(19) United States
(12) Patent Application Publication
(10) Pub. No.: US 2026/0362128 A1
(43) Pub. Date: Nov. 12, 2026

(54) METHODS, ARCHITECTURES, APPARATUSES AND SYSTEMS FOR MEDIUM ACCESS CONTROL (MAC) SECURITY IN WIRELESS SYSTEMS

(71) Applicant: InterDigital Patent Holdings, Inc., Wilmington, DE (US)

(72) Inventors: Keiichi Kubota, Setagaya-Ku (JP); Faris Alfarhan, Montreal (CA); Samuli Turtinen, Ii (FI); Francois Periard, Montreal (CA); Brian Martin, Farnham (GB); Alec Brusilovsky, Downingtown, PA (US); Samir Ferdi, Kirkland (CA); Pascal Adjakple, Great Neck, NY (US); Chia-Hung Wei, Chesterbrook, PA (US); Tuong Hoang, Montreal (CA)

(21) Appl. No.: 19/203,826

(22) Filed: May 9, 2025

(51) Int. Cl. H04W 12/041; H04W 12/10; H04W 76/20

(52) U.S. Cl. CPC H04W 12/041; H04W 12/10; H04W 76/20

(57) ABSTRACT

A wireless transmit/receive unit (WTRU) may detect a security activation trigger. The WTRU may determine a set of base station keys in response to the detected security activation trigger. The WTRU may derive a set of integrity protection and confidentiality keys using the set of base station keys and a network node identifier. The set of integrity protection and confidentiality keys may include a first MAC intermediate key. The WTRU may detect a MAC security key update trigger. The WTRU may derive a second MAC intermediate key in response to the detected MAC security key update trigger. The WTRU may derive a MAC CE integrity protection key and/or a MAC CE confidentiality key using the second MAC intermediate key. The WTRU may send or receive a MAC CE which is security protected using the MAC CE integrity protection key and/or the MAC CE confidentiality key.

### BACKGROUND

The present application is related to the fields of communications, software and encoding, including, for example, to methods, architectures, apparatuses, systems directed to security enforcement at the medium access control (MAC) layer, and more particularly to encryption for MAC control elements (MAC CEs), integrity protection for MAC CEs, encryption for overall data in the MAC layer, and integrity protection for overall data in the MAC layer.

In legacy systems, security enforcement takes place at the PDCP entity. Legacy Access Stratum (AS) security protects only layer 3 dedicated Radio Resource Control (RRC) messages and user plane data in RRC_CONNECTED mode, while MAC Control Elements (CEs), control Protocol Data Units (PDUs), and Common Control Channel (CCCH) messages are not protected.

In next generation wireless systems, such as 6G, lower layer security enforcement and/or per QoS flow security enforcement are expected to be realized. It would be beneficial to provide solutions for MAC security in view of the needs of next generation security enforcement, and to provide techniques to protect lower layer control elements, control PDUs, data, and headers in view of UE computational complexity.

### BRIEF SUMMARY

Briefly stated, in one embodiment, a wireless transmit/receive unit (WTRU) may detect a security activation trigger. The WTRU may derive a set of base station keys in response to the detected security activation trigger. The WTRU may derive a set of integrity protection and confidentiality keys using the set of base station keys and a network node identifier. The set of integrity protection and confidentiality keys may include a first MAC intermediate key. The WTRU may detect a MAC security key update trigger. The WTRU may derive a second MAC intermediate key in response to the detected MAC security key update trigger. The WTRU may derive a MAC integrity protection key and/or a MAC confidentiality key using the second MAC intermediate key. The WTRU may send or receive a MAC CE which is security protected using the MAC CE integrity protection key and/or the MAC CE confidentiality key.

In one embodiment, a WTRU may derive a set of integrity protection and confidentiality keys using a set of base station keys and a network node identifier. The set of integrity protection and confidentiality keys may include a MAC intermediate key. The WTRU may derive a MAC integrity protection key and/or a MAC confidentiality key using the MAC intermediate key. In some examples, the MAC integrity protection key and/or the MAC confidentiality key may be derived using the MAC intermediate key and a network identifier, such as a physical cell identity, a lower layer unit (LLU) identity, and/or an upper layer unit (ULU) identity. The WTRU may generate a MAC CE. The WTRU may determine a count value associated with uplink MAC CE signaling, and determine a sequence number (SN) for the MAC CE from the count value. The WTRU may encrypt the MAC CE using the MAC CE confidentiality key and the count value and/or perform integrity protection on the MAC CE using the MAC CE integrity protection key and the count value. The WTRU may send the encrypted and/or integrity protected MAC CE as a security protected MAC CE which includes at least a portion of the SN.

In one embodiment, a WTRU may derive a set of integrity protection and confidentiality keys using a set of base station keys and a network node identifier. For example, the set of integrity protection and confidentiality keys may include a MAC intermediate key. The WTRU may derive a MAC CE integrity protection key and/or a MAC CE confidentiality key using the MAC intermediate key. The WTRU may receive a security protected MAC CE. The WTRU may decrypt the security protected MAC CE using the MAC CE confidentiality key and a count value associated with downlink MAC CE signaling and/or perform an integrity check on the security protected MAC CE using the MAC CE integrity protection key and the count value.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 1E is a system diagram illustrating a further example RAN that may be used within next generation communication systems, according to one or more embodiments of the present disclosure;

FIG. 2 is a key diagram illustrating an example of key hierarchy generation in a 5G system (5GS), according to one or more embodiments of the present disclosure;

FIG. 3 is a key diagram illustrating a first example of a key hierarchy generation in a 6G system, according to one or more embodiments of the present disclosure;

FIG. 4 is a key diagram illustrating a second example of a key hierarchy generation in a 6G system, according to one or more embodiments of the present disclosure;

FIG. 5 is a key diagram illustrating a third example of a key hierarchy generation in a 6G system, according to one or more embodiments of the present disclosure;

FIG. 6 is a key diagram illustrating a fourth example of a key hierarchy generation in a 6G system, according to one or more embodiments of the present disclosure;

FIG. 7 is a procedural diagram illustrating an example key derivation procedure, according to one or more embodiments of the present disclosure;

FIG. 8 is a procedural diagram illustrating an example transmission procedure for security protection, according to one or more embodiments of the present disclosure;

FIG. 9 is a procedural diagram illustrating an example reception procedure for security protection, according to one or more embodiments of the present disclosure;

FIG. 10 is a procedural diagram illustrating an example key derivation and communication procedure for security protection, according to one or more embodiments of the present disclosure;

FIG. 11 is a procedural diagram illustrating another example transmission procedure for security protection, according to one or more embodiments of the present disclosure; and

FIG. 12 is a procedural diagram illustrating another example reception procedure for security protection, according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

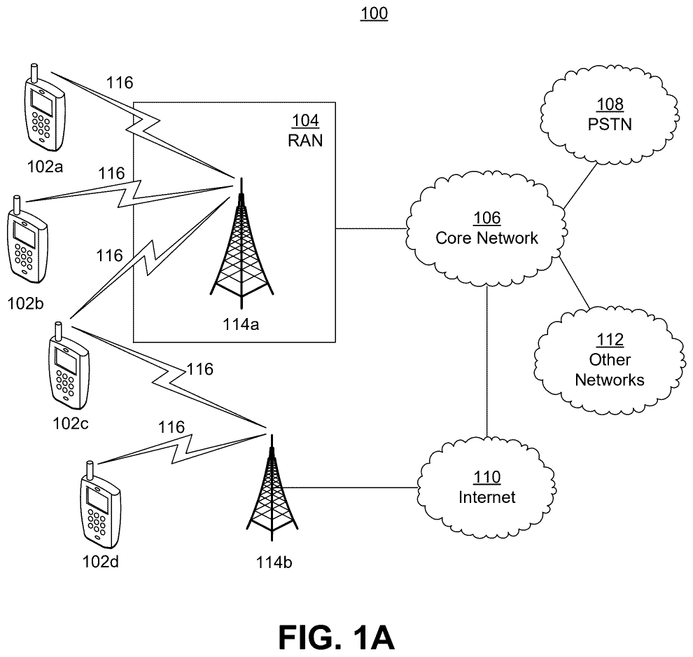

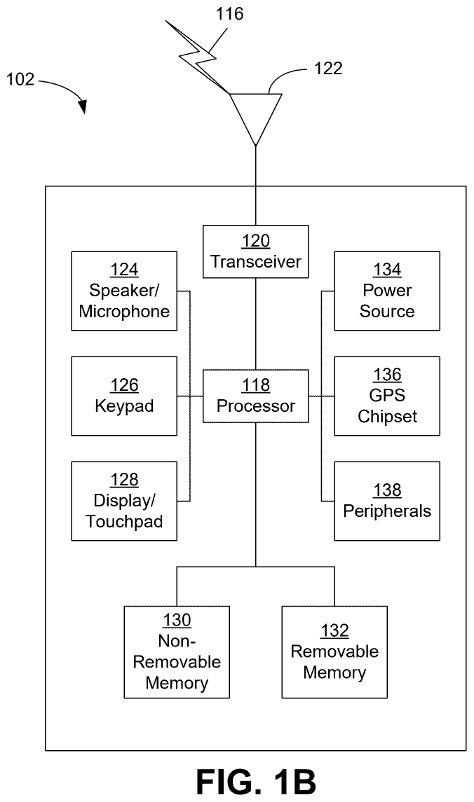

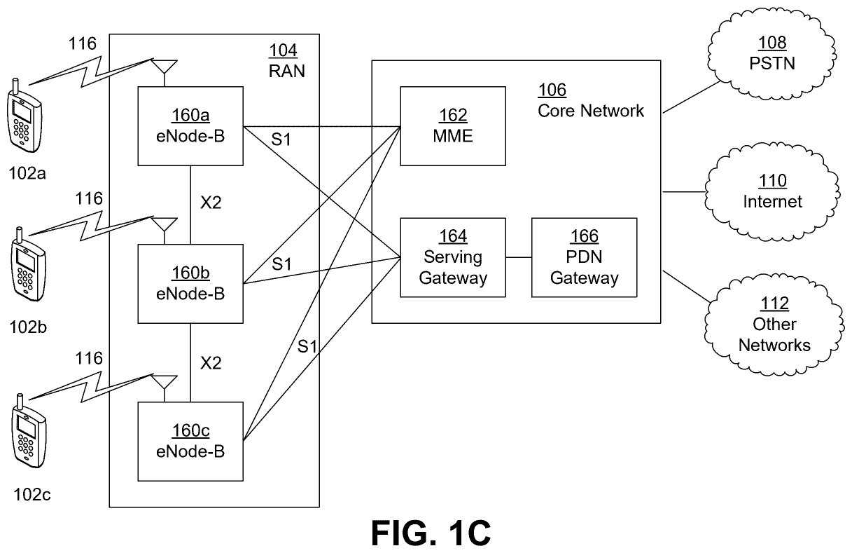

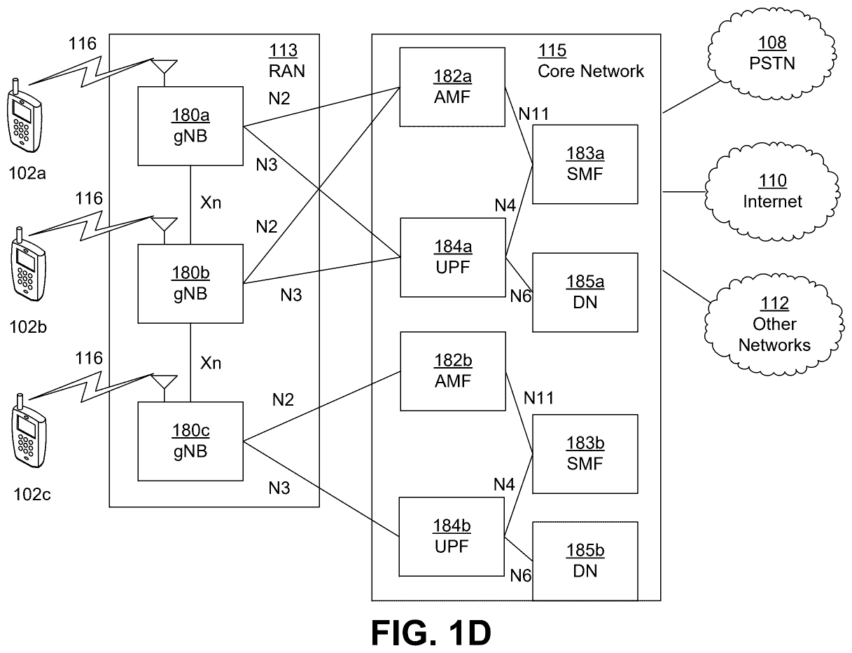

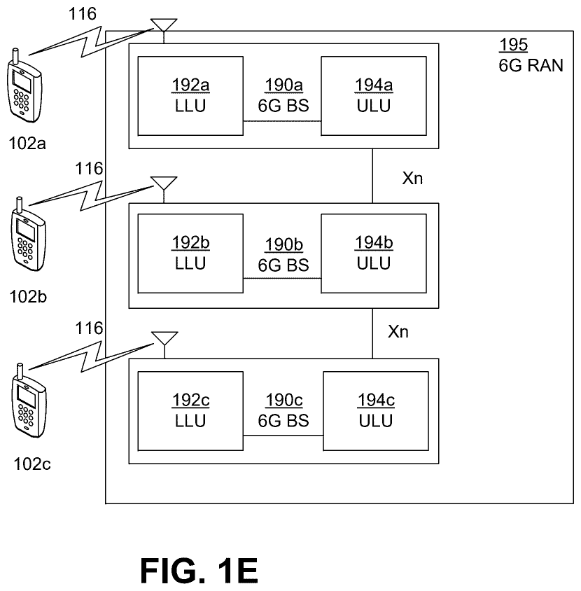

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a customer premises equipment (CPE), a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a 6G base station (e.g., a 6G NB) a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1E is a system diagram illustrating a further example RAN that may be used within next generation (e.g., 6G) communication systems, according to one or more embodiments of the present disclosure. As shown in FIG. 1E, a plurality of WTRUs 102a, 102b, 102c may communicate with 6G BSs 190a, 190b, 190c using transmissions employing a 6G radio access technology. The 6G BSs 190a, 190b, 190c may be provided as part of a 6G RAN 195.

In certain representative embodiments, the 6G BSs 190a, 190b, 190c may employ, or otherwise provide, radio access functionality similar to other RATs described herein. By way of example, and intended to be non-limiting, the protocol stack functionality of a CU, DU, and/or RU of a NR gNB 180 may be split in a 6G communication system. For example, the 6G BS 190a may include a LLU 192a and a ULU 194a, the 6G BS 190b may include a LLU 192b and a ULU 194b, and 6G BS 190c may include a LLU 192c and an ULU 194c.

In certain representative embodiments, the ULU 194a, ULU 194b, ULU 194c may handle processing and functionality associated with one or more upper protocol layers, such as the Packet Data Convergence Protocol (PDCP) layer. Other upper layer functionality may be implemented by a ULU.

In certain representative embodiments, the LLU 192a, LLU 192b, LLU 192c may handle processing and functionality associated with one or more lower protocol layers, such as the MAC layer. Other lower layer functionality may be implemented by a ULU.

In other embodiments, PDCP and/or MAC functionality may be shared between the LLU and the ULU (e.g., as an upper MAC sub-layer and a lower MAC sub-layer).

As described herein, certain aspects of security enforcement functionality may be employed at the LLU 192a, LLU 192b, LLU 192c and/or the ULU 194a, ULU 194b, ULU 194c. Various embodiments and examples of such implementations are described in the following.

### Introduction

In Evolved Universal Terrestrial Radio Access (E-UTRA) (e.g., 4G Long Term Evolution (LTE) and 5G New Radio (NR) systems, security enforcement took place at the PDCP entity. For NR, the PDCP entity is located at a Centralised Unit (CU) and so only higher layer messages (e.g., RRC messages) can be encrypted and integrity-protected. Legacy Access Stratum (AS) security protects only layer 3 dedicated RRC messages and user plane data in RRC_CONNECTED mode, while MAC CEs, control Protocol Data Units (PDUs), and Common Control Channel (CCCH) messages are not protected.

However, the location of security enforcement may need to be revisited in 6G as Lower-layer Triggered Mobility (LTM) procedures may serve as a baseline for 6G mobility and MAC CEs may be (e.g., mainly) involved in LTM mobility and so it may be beneficial to place security enforcement in the MAC entity. There are other sensitive MAC CEs, headers, and control PDUs (e.g. C-RNTI, MAC-I in a PDCP PDU) that may also benefit from encryption. It may also be beneficial for (e.g., some) configurations in 6G to be provided in MAC CEs, such as in addition to or in lieu of RRC signaling, and such configuration signaling may also need to be protected (e.g., as RRC signalling is security enforced).

There is a (e.g., another) possibility that not only MAC CEs but also other data carried by MAC PDUs may also be securely protected at the MAC layer so that (e.g., all) security functions can be provided in one place at a MAC entity. There is (e.g., also) a possibility that integrity protection may be selectively applied at the MAC layer for some PDUs and/or Transport Blocks (TBs) to reduce complexity (e.g., there may be conditions that can be considered for when to protect or not). For example, this may be dependent on any of the data type (e.g., control plane data, user plane data, data plane data, machine learning data, sensing data, operational data, model transfer data, etc.), User Equipment (UE) complexity, processing time involved, and/or on the PDU type within a flow.

From a UE complexity perspective, each service data unit (SDU) has a header (e.g., without concatenation). The NR data structure was designed to support fast data processing, which enables pre-processing before the reception of an UL grant. A consequence is that User Plane Integrity Protection (UPIP) is applied to each SDU, thus resulting in increased UE complexity and UE processing timeline limitations.

In legacy systems, security can be configured per PDU session for NR, or per PDN session for E-UTRA (LTE), and so all the packets associated with a same PDU, or PDN, session would be handled with the same security policies.

However, the per PDU session security enforcement policy may need to be revisited in 6G as some data of a single PDU session may need to be securely protected while other data of the same PDU session may need to be securely protected with a different security level (e.g. only control signaling needs to be encrypted and integrity protected, while user data needs to be encrypted only).

In an example embodiment, a 6G LTM procedure may include MAC security, such as for (e.g., all) user data and control signaling. For example, MAC security may be applied in lower User Plane (UP) layers (e.g., MAC). For example, integrity protection may be applied based (e.g., selectively and/or dependent) on data type, MAC CE, control PDU, and/or MAC header(s).

MAC security requires security key derivations for MAC and COUNT synchronisation and re-synchronisation mechanisms between a UE and a serving network node. They are absent in E-UTRA (LTE) and NR. WCDMA/HSPA systems had some MAC security but these systems used Connection Frame Number (CFN) for COUNT synchronization, but the same principle cannot be applied for 6G. For example, it is unlikely that CFN can be introduced for 6G due to complications related to CFN definition. Accordingly, the requirements for MAC security in 6G systems did not exist in legacy systems.

In legacy systems, security algorithms had the following input parameters:
KEY: a security key (e.g., the encryption key for a specific bearer or MAC; the integrity key for a specific bearer);
BEARER: a value of a bearer identity (RB ID)−1. The RB ID is used as input to avoid different keystreams using an identical set of input parameter values;
DIRECTION: a parameter which shall be set to a value of 0 for UL and 1 for DL. The direction identifier is used as an input to avoid that for the keystreams for the UL and for the DL would use an identical set of input parameter values;
COUNT: a counter value is initialised to 0 when a security context established or re-established and is incremented by 1 when one chunk of data is securely protected by one set of security input parameters;
DATA: the data itself to be protected via encryption or integrity protection.

For example, in Wideband Code Division Multiple Access (WCDMA) and High Speed Packet Access (HSPA), a user equipment (UE) and the network maintain a security key for MAC encryption of each domain (i.e., the circuit switching (CS) domain for voice service or packet data communication service (PS) domain) and a value is maintained based on a connection frame number (CFN) for the CS domain and a count value is maintained based on a radio link control (RLC) sequence number (SN).

For example, in E-UTRA (LTE) and 5G NR, a UE and the network maintain a set of security keys (i.e., one set of keys for encryption and another set of keys for integrity protection) for a Radio Resource Control connection for E-UTRA or NR, and count values are maintained per radio bearer.

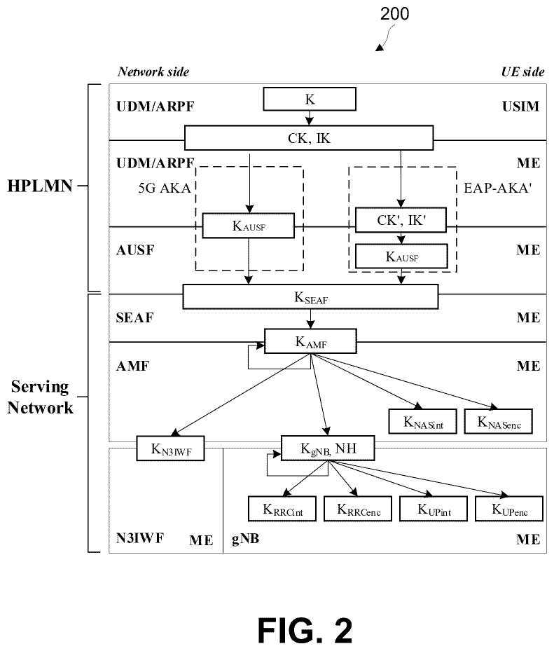

FIG. 2 is a key diagram illustrating an example of key hierarchy generation in a 5G system (5GS), according to one or more embodiments of the present disclosure. In 5G, security keys were derived for RRC signaling and user data security protection as shown in the key hierarchy generation 200 of FIG. 2. All of the security keys were used at PDCP entities in 5G.

In E-UTRA (LTE) and NR, a set of input parameters for ciphering and integrity protection algorithms are defined. For confidentiality, the set of input parameters is defined in TS 33.501, sub-clause D.2.1.1. For integrity protection, the set of input parameters is defined in TS 33.501 subclause D.3.1.1.

In legacy systems, the MAC layer could not convey any sensitive data (e.g., security related information) due to a lack of security. By placing security functionality in the MAC layer, a UE and the network may exchange sensitive data over the MAC layer with lower latency communication, which may improve mobility performance, for example.

In certain representative embodiments, similar security algorithms may be used for security enforcement, such as for 6G security of user data transfer.

### Overview

In certain representative embodiments, MAC control signalling security enforcement may be provided.

In certain representative embodiments, MAC SDU security enforcement may be provided.

In certain representative embodiments, MAC security re-synchronisation may be provided.

In certain representative embodiments, per QoS flow security enforcement may be provided.

In certain representative embodiments, a WTRU 102 may generate (e.g., derive) MAC security keys, such as a first MAC security key for confidentiality (e.g., a MAC confidentiality key) and a second MAC security key for integrity protection (e.g., a MAC integrity protection key). The WTRU 102 may store (e.g., maintain) the MAC security keys and a corresponding COUNT value (e.g., for replay protection).

In certain representative embodiments, a WTRU 102 may detect a security activation trigger and generate (e.g., derive) a (e.g., set of) 6G Base Station (BS) key(s). For example, a security activation trigger may include, among other triggers, any of a change in/of a serving 6G Upper Layer Unit (ULU), and/or reception of a security mode command message.

In certain representative embodiments, the WTRU 102 may generate (e.g., derive), based on the set of 6G BS keys, a set of integrity protection and confidentiality keys. For example, the set of integrity protection and confidentiality keys may include a RRC integrity protection key, an RRC confidentiality key, a UP-integrity protection key, a UP-confidentiality key, and a MAC intermediate key. For example, the set of integrity protection and confidentiality keys may be derived by (e.g., additionally) using a network node identifier. For example, a network node identifier may be any of a physical cell identity, a 6G Lower Layer Unit (LLU) identifier, and/or a 6G ULU identifier.

In certain representative embodiments, the WTRU 102 may determine (e.g., detect) a MAC security key update trigger and generate (e.g., derive) a MAC intermediate key. For example, the MAC security key update trigger may include, among other triggers, a change in/of a serving 6G LLU, and/or a change in/of a serving cell (e.g., via a mobility procedure, such as a handover or an LTM).

In certain representative embodiments, the WTRU 102 may generate (e.g., derive) a MAC CE integrity protection key and a MAC CE confidentiality key. For example, the MAC CE integrity protection key and the MAC CE confidentiality key may be collectively referred to as MAC CE keys. For example, the MAC CE integrity protection key and the MAC CE confidentiality key may be derived based on the MAC intermediate key (e.g., when the MAC intermediate key is newly derived).

In certain representative embodiments, the WTRU 102 may initialize a COUNT value associated with MAC CE signaling to zero (e.g., when the MAC CE keys are derived).

In certain representative embodiments, a WTRU 102 may determine security keys (e.g., MAC CE keys as described above).

In certain representative embodiments, the WTRU 102 may perform (e.g., DL) security enforcement using the derived MAC security keys. For example, the WTRU 102 may receive a MAC CE (e.g., from a lower layer).

In certain representative embodiments, the WTRU 102 may (e.g., for decryption of a received MAC CE) use the MAC confidentiality key and a COUNT value associated with DL MAC control signaling as the KEY and COUNT input parameters for a confidentiality algorithm (e.g., configured by the network).

In certain representative embodiments, the WTRU 102 may (e.g., for an integrity check of a received MAC CE) use the MAC integrity protection key and a COUNT value associated with DL MAC control signaling as the KEY and COUNT input parameters for an integrity protection algorithm (e.g., configured by the network).

In certain representative embodiments, the WTRU 102 may perform SN-based management of the COUNT value. For example, a security protected MAC CE may be associated with a SN (e.g., defined per direction). The SN may be the least significant N-bits (e.g., LSBs) of the COUNT value, where N is an integer value. The SN may be initialized upon COUNT value initialization. The remaining MSBs of the COUNT value may be incremented by 1 when the SN is wrapped around. The SN may be included in a MAC CE, such as in a SN field which is added in a MAC CE which requires security protection.

In certain representative embodiments, for the DL direction, the WTRU 102 may update the COUNT value associated with DL MAC control signalling with the SN given by successfully received security protected downlink MAC control signalling.

In certain representative embodiments, a WTRU 102 may determine security keys (e.g., MAC CE keys as described above).

In certain representative embodiments, the WTRU 102 may generate a MAC CE (e.g., which requires security protection). For example, the WTRU 102 may determine that security protection should be, or is, provided for the MAC CE. For example, the WTRU 102 may receive a security protection requirement (e.g., signalled by the network), such as for mobility related signalling including a LTM cell switch command.

In certain representative embodiments, the WTRU 102 may perform (e.g., UL) security enforcement using the derived MAC security keys. For example, the WTRU 102 may generate a MAC CE (e.g., for UL transmission by a lower layer). The WTRU 102 may determine the COUNT value associated with MAC CE control signaling (e.g., for the UL direction) and determine a SN associated with the MAC CE based on the determined COUNT value. For example, the WTRU 102 may append the SN, or a subset of the SN bits (e.g., include a predefined number of bits from the lowest significant bits of the COUNT value), to the generated MAC CE. For example, the SN may be the (e.g., N) least significant bits of the COUNT value. For example, the remaining most significant bits of the COUNT value may be maintained as a Hyper Frame Number (HFN).

In certain representative embodiments, the WTRU 102 may maintain the HFN as part of managing the COUNT value. For example, if the WTRU 102 receives a MAC CE that is (e.g., determined to be) associated with a SN of ‘x’, the corresponding COUNT value may be be set to [HFN, x].

In certain representative embodiments, the WTRU 102 may apply ciphering (e.g., encryption) to the MAC CE using the MAC confidentiality key and the determined COUNT value.

In certain representative embodiments, the WTRU 102 may apply integrity protection to the MAC CE using the MAC integrity protection key and the determined COUNT value.

In certain representative embodiments, the WTRU 102 may transmit the security protected MAC CE. For example, the WTRU 102 may increment the COUNT value by 1 when the MAC CE is delivered to a lower layer (e.g. PHY) for transmission.

As used herein, the term “security protection” may refer to ciphering (e.g., encryption/decryption) and/or integrity protection and/or integrity checking. For example, a receiving entity may perform decryption and/or an integrity check as a security protection operation. For example, a transmitting entity may perform encryption and/or integrity protection as a security protection operation.

As used herein, the term “data flow” may refer to a (e.g., generic) communication pathway in 6G Layer 2 (e.g., between MAC and RLC layers). For example, a data flow may be equivalent or similar to a “logical channel” as used in legacy systems (e.g., E-UTRA (LTE), NR).

As used herein, the term “MAC CE” may refer to (e.g., generic) MAC control signaling. For example, the term “MAC CE” may be used as a general term to cover not only MAC CE equivalents to those used in legacy systems but also refer to any control signaling introduced at the MAC entity in 6G. The terms “MAC CE” and “MAC control signaling” may be used interchangeably.

As used herein, the term “6G ULU” may refer to a logical unit at the network side. For example, a 6G ULU may comprise one or more (e.g., upper layer) protocol entities (e.g., RRC, PDCP, and/or SDAP). For example, a 6G ULU may be equivalent or similar to a NR Centralized Unit (CU).

As used herein, the term “6G LLU” may refer to a logical unit at the network side. For example, a 6G LLU may perform (e.g., real-time) processing for data communication. For example, a 6G LLU may comprise one or more (e.g., lower layer) protocol entities (e.g. RLC, MAC, and/or PHY). For example, a 6G LLU may be equivalent or similar to a NR Distributed Unit (DU). In some representative embodiments, a 6G ULU and a 6G LLU may reside in a single hardware box. In some representative embodiments, a 6G ULU and a 6G LLU may reside at separate locations and/or hardware boxes. In some representative embodiments, a 6G ULU and a 6G LLU may reside in a cloud environment.

### MAC Control Signaling Security Enforcement

In legacy systems (e.g., E-UTRA (LTE) and NR), security enforcement was not provided in a MAC entity and any data generated by the MAC entity was unable to be security protected.

In certain representative embodiments, a WTRU 102 may perform a procedure to provide MAC CE security protection. For MAC CE security enforcement, a MAC confidentiality key and a MAC integrity protection key (e.g., MAC CE keys) need to be derived for MAC CE confidentiality and integrity protection. For example, the MAC CE keys may be stored (e.g., maintained) where a MAC entity resides, such as a 6G LLU.

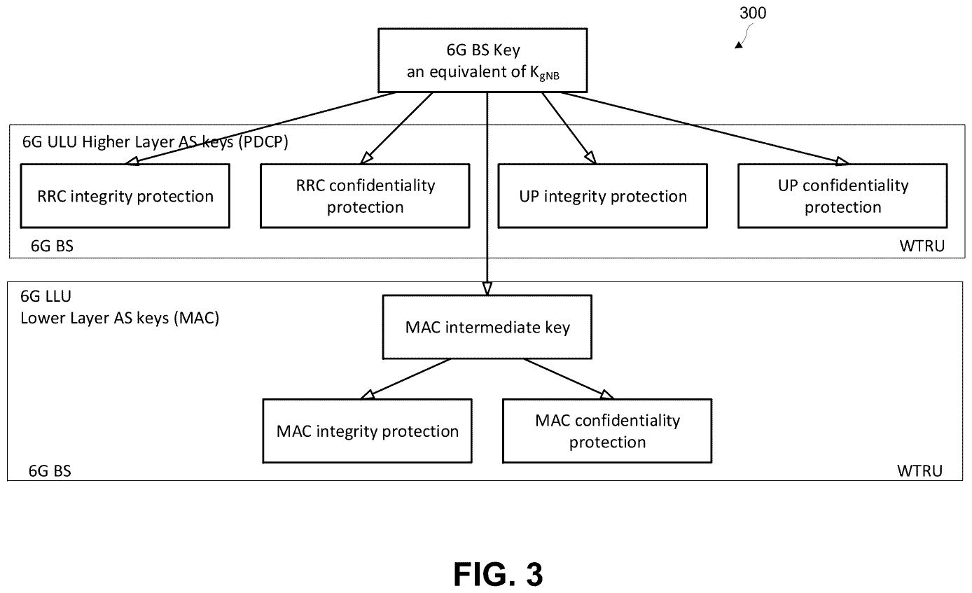

FIG. 3 is a key diagram illustrating a first example of a key hierarchy generation 300 in a 6G system, according to one or more embodiments of the present disclosure. As shown in the key hierarchy generation 300 of FIG. 3, a 6G BS key, or set of 6G BS keys, may be used (e.g., as at least part of the basis) to generate (e.g., derive) a set of integrity protection and confidentiality keys. For example, the 6G BS key may be provided by a 6G Core Network (CN). For example, the 6G BS key may be equivalent or similar to a K_{gNB} in 5G NR. For example, the set of integrity protection and confidentiality keys may include (e.g., any of) a MAC intermediate key, a RRC integrity protection key, an RRC confidentiality key, a UP-integrity protection key, and/or a UP-confidentiality key. The MAC intermediate key may be used (e.g., as at least part of the basis) to generate (e.g., derive) a MAC integrity protection key and a MAC confidentiality key. The set of integrity protection and confidentiality keys may be higher layer (e.g., PDCP or sub-layer) AS keys. The MAC integrity protection key and the MAC confidentiality key may be lower layer (e.g., MAC or sub-layer) AS keys.

As shown in FIG. 3, the RRC integrity protection key, the RRC confidentiality key, the UP-integrity protection key, and the UP-confidentiality key may be (e.g., separately) generated by (e.g., at) a 6G ULU and a WTRU 102 (e.g., at the PDCP layer). The MAC intermediate key, the MAC integrity protection key and the MAC confidentiality key may be (e.g., separately) generated by a 6G LLU and the WTRU 102 (e.g., at the MAC layer).

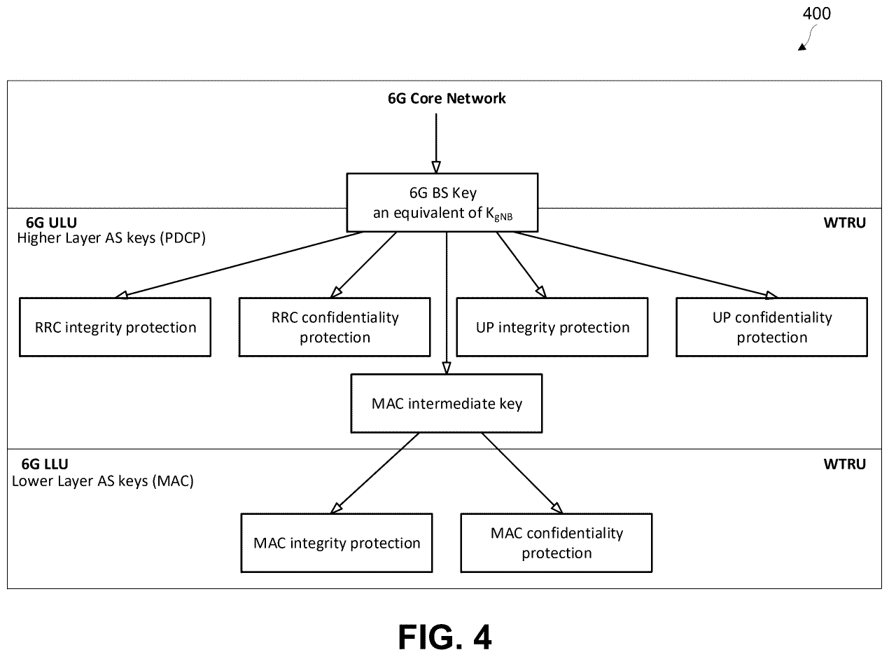

FIG. 4 is a key diagram illustrating a second example of a key hierarchy generation 400 in a 6G system, according to one or more embodiments of the present disclosure. As shown in FIG. 4, the key hierarchy generation 400 may include the set of integrity protection and confidentiality keys, including the MAC intermediate key, being (e.g., separately) generated by the 6G ULU and the WTRU 102. Similar to FIG. 3, the MAC integrity protection key and the MAC confidentiality key may be (e.g., separately) generated by the 6G LLU and the WTRU 102 (e.g., at the MAC layer).

As shown in FIG. 3, a MAC intermediate key may be maintained in the 6G LLU on the network side and by a MAC entity at the WTRU side. For example, the MAC intermediate key may be newly derived in response to a change of the serving LLU for the WTRU 102.

As shown in FIG. 4, a MAC intermediate key may be maintained in the 6G ULU on the network side and by a PDCP entity at the WTRU side. For example, the MAC intermediate key may be newly derived in response to a change of the serving ULU for the WTRU 102.

In certain representative embodiments, the MAC integrity key and the MAC confidentiality key may (e.g., shall) be (e.g., both and/or newly) derived in response to a change of a serving 6G LLU and/or a change of a serving cell for the WTRU 102.

In certain representative embodiments, a WTRU 102 may determine (e.g., derive) a 6G BS key (e.g., equivalent or similar to K_{gNB}) upon a security activation (e.g., receiving a security mode command) and/or upon a change of the serving 6G ULU (e.g., after the security activation).

In certain representative embodiments, the WTRU 102 may determine (e.g., derive) a MAC intermediate key from the 6G BS key. For example, the WTRU 102 may (e.g., indirectly) derive the MAC intermediate key using the 6G BS key as a basis. For example, the WTRU 102 may (e.g., also) determine any of an RRC integrity protection key, an RRC confidentiality key, a UP-integrity protection key, and/or a UP-confidentiality key from the 6G BS key (e.g., when the 6G BS key is newly derived).

In certain representative embodiments, the WTRU 102 may determine (e.g., newly derive) a MAC intermediate key upon a change of the serving 6G LLU. For example, a MAC intermediate key may be derived based on a cell identity and/or an identity of the 6G LLU.

In certain representative embodiments, the WTRU 102 may determine (e.g., derive) a MAC CE integrity protection key and a MAC CE confidentiality key (e.g., MAC CE keys) for MAC CE security protection from the MAC intermediate key, such as when a MAC intermediate key is newly derived (e.g., upon security activation, a serving 6G LLU change, and/or a serving cell change). For example, the MAC CE keys may be (e.g., indirectly) derived using the MAC intermediate key as a basis. For example, the WTRU 102 may determine (e.g., derive) the MAC CE keys based on a cell identity and/or an identity of the 6G LLU.

In certain representative embodiments, the WTRU 102 may initialize the COUNT value associated with the MAC CE signalling to zero when the MAC integrity protection key and MAC confidentiality key are (e.g., newly) derived.

In certain representative embodiments, a WTRU 102 may maintain (e.g., manage) the security keys as described above.

In certain representative embodiments, the WTRU 102 may perform security enforcement on MAC CEs (e.g., in the uplink direction and/or the downlink direction).

In certain representative embodiments, the WTRU 102 may generate a MAC CE which requires security protection. For example, a security protection requirement may be signaled by the network, such as when security protection is required (e.g., for mobility related signaling like a LTM cell switch command).

In certain representative embodiments, for encryption, the WTRU 102 may use the MAC confidentiality key and the COUNT value (e.g., associated with uplink MAC CEs) as the KEY and COUNT input parameters for a confidentiality algorithm (e.g., configured by the network).

In certain representative embodiments, for integrity protection, the WTRU 102 may use the MAC integrity protection key and the COUNT value (e.g., associated with uplink MAC CEs) as the KEY and COUNT input parameters for an integrity protection algorithm (e.g., configured by the network). For example, the WTRU 102 may determine (e.g., generate) a Message Authentication Code for Integrity (MAC-I) via processing the integrity-protection algorithm for the MAC CE. The WTRU 102 may place the MAC-I for the MAC-CE in a MAC PDU including the MAC CE. The MAC PDU may be provided to a lower layer for transmission.

In certain representative embodiments, the WTRU 102 may receive a MAC CE which is security protected. For example, the WTRU 102 may determine that (e.g., whether or not) the MAC CE is security protected.

In certain representative embodiments, for decryption, the WTRU 102 may use the MAC confidentiality key and the COUNT value (e.g., associated with downlink MAC control signaling) as the KEY and COUNT input parameters for a confidentiality algorithm (e.g., configured by the network).

In certain representative embodiments, for integrity protection, the WTRU 102 may use the MAC integrity protection key and the COUNT value (e.g., associated with downlink MAC control signaling) as the KEY and COUNT input parameters for an integrity protection algorithm (e.g., configured by the network).

### COUNT Management

In certain representative embodiments, a COUNT value (e.g., associated with downlink MAC signaling and/or uplink MAC signaling) may be maintained (e.g., managed) by a WTRU 102 and the network.

In certain representative embodiments, the COUNT value may be maintained (e.g., incremented) based on SNs. For example, a security protected MAC CE may be associated with (e.g., include) a SN. In certain embodiments, the SN may be specific (e.g., specifically defined) for the uplink direction or the downlink direction. For example, the SN may correspond to (e.g., be) N-bits of the COUNT value. The N-bits may be the LSBs of the COUNT value. For example, a SN may be initialized upon COUNT value initialization (e.g., in a particular direction). The remaining MSBs of the COUNT value may be incremented by one when the SN is wrapped around. For example, a MAC CE which requires or uses security protection may include a SN (e.g., a SN field is added to, or provided for, the MAC CE).

As an example, for uplink communication, a WTRU 102 may increment the SN by one when the WTRU 102 delivers security protected (e. g,, encrypted and/or integrity protected) uplink MAC control signaling (e.g., MAC CEs) to a lower layer (e.g., PHY) for subsequent processing.

As an example, for downlink communication, a WTRU 102 may update the COUNT value for downlink MAC control signaling with a SN given by a successfully received security protected downlink MAC control signalling (e.g., MAC SDU/PDU). Various examples for determination of the COUNT value (e.g., a DL COUNT value and/or an UL COUNT value) for MAC data units are described herein.

In certain representative embodiments, the COUNT value may be maintained (e.g., incremented) based on implicit information. As an example, for uplink communication, when the WTRU 102 delivers a security protected MAC CE to the lower layer (e.g., PHY), the WTRU 102 may increment the COUNT value (e.g., for uplink MAC CEs) by one. As an example, for downlink communication, when the WTRU 102 receives a downlink MAC CE, the WTRU 102 may increment the COUNT value (e.g., for downlink MAC control signaling) by one.

In certain representative embodiments, the COUNT value may be maintained (e.g., incremented) based on (e.g., borrowed from) a user data SN. As an example, for uplink communication, when a WTRU 102 (e.g., MAC entity) generates a MAC CE, which requires security protection, the WTRU 102 may use a SN, which is present in the user data, which is concatenated in the same MAC PDU as the MAC CE to set the (e.g., uplink) COUNT value (e.g., the LSBs of the COUNT are set to the SN borrowed from a user data MAC SDU) and the uplink MAC CE may indicate the logical channel ID associated with the SN (e.g., the source where the SN is borrowed from). As an example, for downlink communication, when a WTRU 102 (e.g., MAC entity) receives a security protected MAC CE, the WTRU 102 may determine a SN in the MAC SDU associated with a data flow indicated by the received MAC CE and set the (e.g., downlink) COUNT value based on this SN (e.g., the LSBs of the downlink COUNT value are set to the SN). For example, the SN of the user data may be associated with any of the PDCP layer, RLC layer, and/or QoS flow level.

In certain representative embodiments, the transmitting MAC entity may use a single set of the COUNT value and MAC CE keys per MAC PDU to secure one or more MAC CEs in the same MAC PDU. For example, a same COUNT value may be applied for all the MAC CEs within a same MAC PDU and a single SN may be present in the MAC PDU header for security enforcement purposes.

### MAC SDU Security Enforcement

In certain representative embodiments, security enforcement may be (e.g., independently) applied to MAC UP data, such as MAC SDUs. In some representative embodiments, security enforcement may be applied not only to MAC CEs but also may be applied to MAC UP data. For example, MAC UP security enforcement may be applied on top of the MAC CE security enforcement.

In certain representative embodiments, for MAC UP security enforcement, a confidentiality key and/or an integrity protection key may need to be generated (e.g., derived) for confidentiality and/or integrity protection of the user data of MAC layer (e.g., MAC SDUs). For example, these keys may be stored in the unit where the MAC entity resides, such as a DU (e.g., where real time processing for data communication takes place).

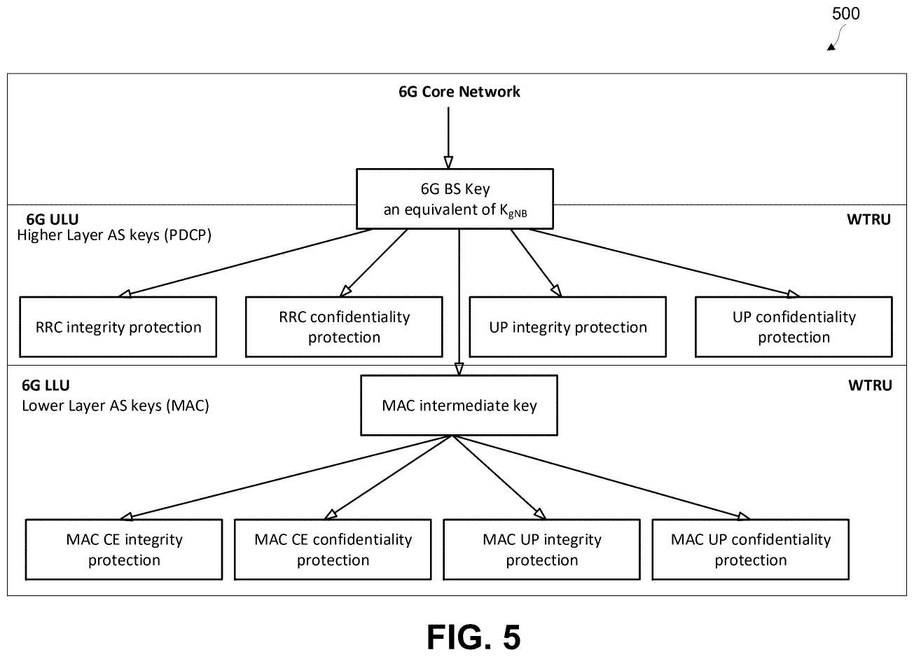

FIG. 5 is a key diagram illustrating a third example of a key hierarchy generation 500 in a 6G system, according to one or more embodiments of the present disclosure. As shown in the key hierarchy generation 500 of FIG. 5, a 6G BS key, or set of 6G BS keys, may be used (e.g., as at least part of the basis) to generate (e.g., derive) a set of integrity protection and confidentiality keys. For example, the 6G BS key may be provided by a 6G Core Network (CN). For example, the 6G BS key may be equivalent or similar to a K_{gNB} in 5G NR. For example, the set of integrity protection and confidentiality keys may include (e.g., any of) a MAC intermediate key, a RRC integrity protection key, an RRC confidentiality key, a UP-integrity protection key, and/or a UP-confidentiality key. The MAC intermediate key may be used (e.g., as at least part of the basis) to generate (e.g., derive) a MAC CE integrity protection key, a MAC CE confidentiality key, a MAC UP integrity protection key, and a MAC UP confidentiality key. The set of integrity protection and confidentiality keys may be higher layer (e.g., PDCP or sub-layer) AS keys. The MAC CE integrity protection key, MAC CE confidentiality key, MAC UP integrity protection key, and MAC UP confidentiality key may be lower layer (e.g., MAC or sub-layer) AS keys.

In some representative embodiments, the MAC intermediate key may be used to generate a MAC UP integrity protection key and/or a MAC UP confidentiality key independently or separately from the MAC CE integrity protection key and/or the MAC CE confidentiality key.

In some representative embodiments, the MAC intermediate key may be used to only generate a MAC UP integrity protection key and/or a MAC UP confidentiality key without generating a MAC CE integrity protection key and/or a MAC CE confidentiality key.

As shown in FIG. 5, the RRC integrity protection key, the RRC confidentiality key, the UP-integrity protection key, and the UP-confidentiality key may be (e.g., separately) generated by (e.g., at) a 6G ULU and a WTRU 102 (e.g., at the PDCP layer). The MAC intermediate key, the MAC CE integrity protection key, the MAC CE confidentiality key, the MAC UP integrity protection key, and the MAC UP confidentiality key may be (e.g., separately) generated by a 6G LLU and the WTRU 102 (e.g., at the MAC layer).

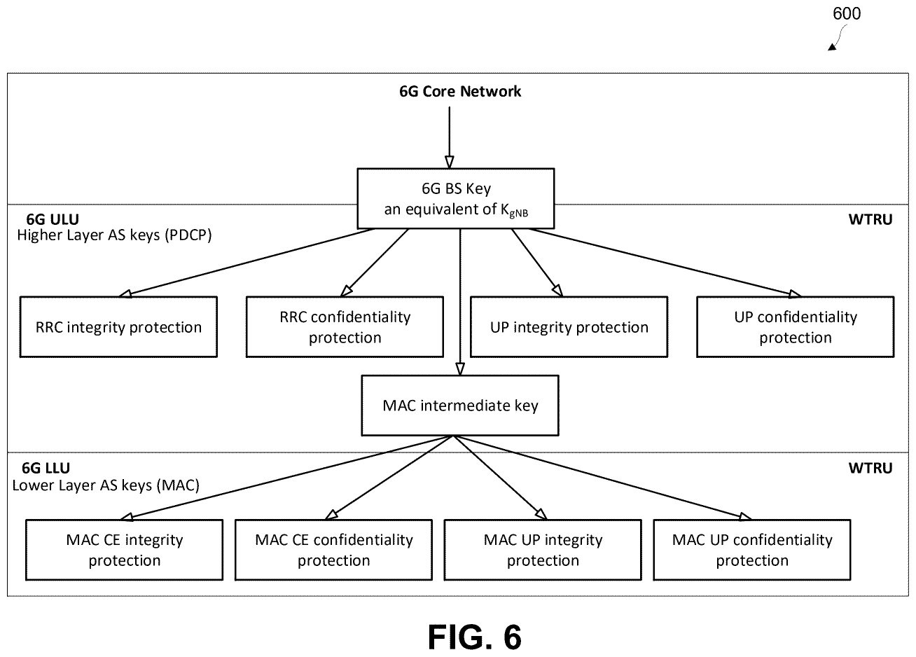

FIG. 6 is a key diagram illustrating a fourth example of a key hierarchy generation 600 in a 6G system, according to one or more embodiments of the present disclosure. As shown in FIG. 6, the key hierarchy generation 600 may include the set of integrity protection and confidentiality keys, including the MAC intermediate key, being (e.g., separately) generated by the 6G ULU and the WTRU 102. Similar to FIG. 5, the the MAC CE integrity protection key, the MAC CE confidentiality key, the MAC UP integrity protection key, and the MAC UP confidentiality key may be (e.g., separately) generated by the 6G LLU and the WTRU 102 (e.g., at the MAC layer).

As shown in FIGS. 5 and 6, the MAC intermediate key may be maintained at the 6G LLU or may be maintained at the 6G ULU at the network side.

In certain representative embodiments, a WTRU 102 may generate (e.g., derive) a 6G BS key, such as upon security activation (e.g., receiving a security mode command) and/or upon a change of the serving 6G LLU (e.g., after security activation). For example, the 6G BS key may be equivalent or similar to a K_{gNB}.

In certain representative embodiments, the WTRU 102 may generate (e.g., derive) any of an RRC integrity protection key, an RRC confidentiality key, a UP-integrity protection key, a UP-confidentiality key, and/or a MAC intermediate key from the 6G BS key (e.g., when the 6G BS key is newly derived).

In certain representative embodiments, the WTRU 102 may generate (e.g., newly derive) a MAC intermediate key, such as upon a change of a serving 6G LLU. For example, the MAC intermediate key may be derived based on (e.g., at least in part on) a cell identity and/or an identity of a 6G LLU. A MAC UP integrity protection key and/or a MAC UP confidentiality key (e.g., MAC UP keys) for MAC UP protection may be derived from the MAC intermediate key (e.g., when a MAC intermediate key is newly derived, such as upon security activation or a serving 6G LLU change). As another example, the MAC UP keys may be derived when a serving cell of the WTRU 102 is changed to another cell.

In certain representative embodiments, the WTRU 102 may initialize a COUNT value (e.g., associated with each data flow) to zero when the MAC UP keys are (e.g., newly) derived and/or when the MAC UP keys are applied to, or by, the MAC entity. For example, the timing of key derivation and the starting time of using of the new key(s) may be different. As one example, a WTRU 102 may newly derive MAC security keys during the preparation phase of mobility procedure and may (e.g., only) apply the keys after (e.g., successful) completion of mobility procedure.

In certain representative embodiments, a WTRU 102 may maintain (e.g., manage) the MAC UP security keys as described above. In certain representative embodiments, the WTRU 102 may (e.g., also) maintain MAC CE keys as described above.

In certain representative embodiments, the WTRU 102 may perform security enforcement on MAC user data (e.g., MAC SDUs) which requires security protection. For example, a security protection requirement may be signaled by the network (e.g., for factory automation control signaling).

In certain representative embodiments, the WTRU 102 may perform uplink security enforcement on MAC UP data. For encryption, a MAC UP confidentiality key, an uplink COUNT value (e.g., for the corresponding data flow), and a data flow identity (e.g., for uplink MAC user plane data which requires confidentiality) may be used as KEY, COUNT and BEARER input parameters for a confidentiality algorithm (e.g., configured by the network) to encrypt the corresponding user data. For example, the security requirements may be configured by the network, such as per data flow and/or logical channel. For integrity protection, a MAC UP integrity protection key, a COUNT value, and a data flow identity (e.g., for uplink MAC user plane data which requires integrity-protection) may be used as the KEY, COUNT and BEARER input parameters for an integrity protection algorithm (e.g., configured by the network) to integrity-protect the corresponding user data. For example, the security requirements may be configured by the network, such as per data flow and/or logical channel. For example, a MAC-I may be generated after processing for integrity-protection for the MAC user data. The MAC-I may be placed in (e.g., carried by (sub)header(s) in) the MAC PDU that includes the MAC user data.

In certain representative embodiments, the WTRU 102 may perform downlink security enforcement on MAC UP data. For decryption, a MAC UP confidentiality key, a downlink COUNT value (e.g., for the corresponding data flow), and a data flow identity (e.g., for downlink MAC user plane data which requires confidentiality) may be used as the KEY, COUNT and BEARER input parameters for a confidentiality algorithm (e.g., configured by the network) to decrypt the corresponding user data. For an integrity check, a MAC UP integrity protection key, a downlink COUNT value (e.g., for the corresponding data flow) and a data flow identity (e.g., for downlink MAC user plane data which requires integrity-protection) may be used as the KEY, COUNT and BEARER input parameters for an integrity protection algorithm (e.g., configured by the network) to perform an integrity-check on the corresponding user data.

### COUNT Management

In certain representative embodiments, a COUNT value (e.g., associated with downlink MAC user data and/or uplink MAC user data) may be maintained (e.g., managed) by a WTRU 102 and the network.

In certain representative embodiments, the COUNT value may be maintained (e.g., incremented) based on SNs. For example, a security protected MAC SDU may be associated with a SN. In certain embodiments, the SN may be specific (e.g., specifically defined) for the uplink direction or the downlink direction. For example, the SN may correspond to (e.g., be) N-bits of the COUNT value. The N-bits may be the LSBs of the COUNT value. For example, a SN may be initialized upon COUNT value initialization (e.g., in a particular direction). The remaining MSBs of the COUNT value may be incremented by one when the SN is wrapped around. For example, the SN may be included in a MAC sub-header of a MAC SDU (e.g., a SN field is added in the MAC sub-header for upper layer data which requires security protection and the security requirements may be configured by the network).

As an example, for uplink communication, the WTRU 102 may increment the SN by one when the WTRU 102 delivers a security protected uplink MAC SDU to a lower layer (e.g., PHY) for subsequent processing.

As an example, for downlink, the WTRU 102 may update the COUNT value for downlink MAC SDUs with the SN given by a successfully received security protected downlink MAC SDU's MAC sub-header.

In certain representative embodiments, the COUNT value may be maintained (e.g., incremented) based on implicit information. For uplink communication, when the WTRU 102 (e.g., MAC entity) delivers a security protected MAC SDU to the lower layer (e.g., PHY), the WTRU 102 (e.g., MAC entity) may increment the COUNT value for the corresponding uplink data flow by one. For downlink communication, when the WTRU 102 (e.g., MAC entity) receives a downlink MAC SDU, then the WTRU 102 (e.g., MAC entity) may increment the COUNT value for the corresponding downlink data flow by one.

In certain representative embodiments, a WTRU 102 may determine whether, or not, MAC user data is security protected. For example, the WTRU 102 may distinguish security protected MAC user data (e.g., from non-security protected data) based on any of (i) the presence of a COUNT value for the concerned MAC SDU, (ii) a configuration of the data flow (e.g., whether any security protection(s) are applied for a data flow or not based on the configuration associated with the concerned data flow) or (iii) a combination of (i) and (ii).

In certain representative embodiments, all MAC SDUs in a single MAC PDU may be security-protected via a set of a single COUNT value and MAC UP keys (e.g., for each direction). For example, a WTRU 102 may maintain a (e.g., single) UP COUNT value per MAC entity for each direction and the WTRU 102 may respectively set the KEY, COUNT and BEARER input parameters for the security algorithm to the corresponding MAC UP key, the single UP COUNT value for the direction and a hard-coded value (e.g., 0).

In certain representative embodiments, the maintenance of the single UP COUNT value may be based on a SN and/or implicit information.

In some embodiments, a security protected MAC PDU is associated with a SN (e.g., one SN for uplink and another SN for downlink). As an example, the SN may be the N LSBs of the single UP COUNT value (e.g., the SN is initialized upon the COUNT value initialization). The remaining MSBs of the COUNT value may be incremented by one when the SN is wrapped around. A SN field may included in a MAC PDU header, which corresponds to a MAC PDU including user data requiring security protection(s).

For uplink communication, the WTRU 102 may increment the SN by one when the WTRU 102 delivers a security protected uplink MAC PDU to a lower layer (e.g., PHY).

For downlink, the WTRU 102 may update the COUNT value (e.g., for downlink MAC UP data) with the SN of the successfully received downlink MAC PDU. For example, the SN may be carried by a SN field of the successfully received downlink MAC PDU.

In some embodiments, for uplink communications, when the WTRU 102 (e.g., MAC entity) delivers a security protected MAC PDU to the lower layer (e.g., PHY), the WTRU 102 may increment the COUNT value (e.g., for the corresponding uplink data flow) by increment. In some embodiments, for downlink communications, when the WTRU 102 (e.g., MAC entity) receives a downlink MAC PDU, then the WTRU 102 (e.g., MAC entity) may increment the COUNT value (e.g., for corresponding downlink data flow) by one.

In certain representative embodiments, a WTRU 102 may determine whether, or not, MAC user data is security protected. For example, the WTRU 102 may distinguish security protected MAC user data (e.g., from non-security protected data) based on any of (i) the presence of a COUNT value for the concerned MAC PDU, (ii) a MAC security configuration (e.g., whether any security protection(s) are applied for MAC PDUs or not based on the configuration) or (iii) a combination of (i) and (ii).

### Security Re-Synchronization

In certain representative embodiments, synchronization of a COUNT value may be performed between a WTRU 102 and a BS. MAC security enforcement may require COUNT value synchronisation between a WTRU 102 and a serving BS. For example, both ends may need to hold exactly the same COUNT value to process specific data (e.g., a MAC CE, MAC SDU, and/or MAC PDU) for encryption, decryption, integrity-protection and/or integrity-check. For example, the COUNT value may become non-synchronized, and a receiver side of security-protected data may not be able to be perform decrypting and/or integrity-checking properly. Thus, a re-synchronisation mechanism of COUNT values at both ends needs to be defined for the case of COUNT value out-of-sync.

In certain representative embodiments, the COUNT value may fall out of synchronization. For example, the transmitter side may keep incrementing the COUNT value while the receiver side fails to receive certain data units (e.g., MAC PDUs, MAC CEs and/or MAC SDUs) consecutively. For the case of a SN-based solution, if the receiver fails to receive more than half the SN space in consecutive data units (e.g., if the SN number field is 6-bits, then 2\hat{ }6/2=32 and so if the receiver fails to receive more than 32 data units consecutively), then the receiver can no longer identify the correct COUNT value for a received data unit. This situation may arise, for example, in bad radio conditions. As another example, the correct COUNT value may be lost due to radio link failure (RLF).

### COUNT Desynchronization Detection

In certain representative embodiments, a WTRU 102 may need to detect a COUNT desynchronisation event prior to initiating a recovery mechanism for the desynchronisation.

In certain representative embodiments, a WTRU 102 may maintain a variable to count the number of integrity-check failures (e.g., an integrity-check failure count). For example, this variable may be defined per COUNT value (e.g., one for MAC CE for each direction, one for MAC user data (MAC SDU or MAC PDU) for each direction). This variable may be initialized to zero when the associated COUNT value is initialized to zero.

In certain representative embodiments, the WTRU 102 may increment the variable integrity-check failure count corresponding to the received integrity-protected data unit (e.g., MAC CE, MAC SDU or MAC PDU) by one when the WTRU 102 observes an integrity-check failure for the received integrity-protected data.

In some embodiments, the integrity-check failure count may be updated based on the occurrence of a successful integrity-check. For example, the variable integrity check failure count may be decremented by one if the WTRU 102 receives an integrity-protected data unit (e.g., MAC CE, MAC SDU or MAC PDU) and the integrity-check thereof is successful.

In some embodiments, the variable integrity-check failure count may be initialized to zero if the WTRU 102 receives an integrity-protected data unit (e.g., MAC CE, MAC SDU or MAC PDU) a certain number (e.g., N) of consecutive times and all of those integrity-checks are successful. For example, the number (e.g., N) may be configured by the network or may be hard coded in a specification.

In certain representative embodiments, when one of the integrity-check failure counts reaches a certain threshold, the WTRU 102 (e.g., MAC entity) may indicate the integrity-check failure event (e.g., to the upper layer of the WTRU 102). The threshold may be either hard coded in a specification or may be configured by the network.

In certain representative embodiments, a WTRU 102 may perform a recovery mechanism for security desynchronization.

In certain representative embodiments, a WTRU 102, such as an upper layer (e.g., RRC) of the WTRU 102, may determine a RLF (e.g., upon reception of the integrity-check failure event indication from a lower layer). The WTRU 102 (e.g., RRC layer) may initiate a recovery procedure, such as a RRC re-establishment procedure (e.g., by sending a recovery request message, such as RRCReestablishmentRequest message or the like).

In some embodiments, a WTRU 102 may include a recovery cause (e.g., Re-establishment cause) indicating the security de-synchronization failure such as “securityFailure” in a recovery request message.

In certain representative embodiments, a WTRU 102 may perform key derivations (e.g., as described herein) during (e.g., in the middle of) the recovery procedure, such as upon reception of a response towards a recovery request message (e.g., a RRCReestablishment message from the network). For example, any corresponding COUNT values may be initialized (e.g., to zero) upon the key derivations. The WTRU 102 may apply the newly derived keys (e.g., MAC CE keys and/or MAC UP keys) after re-synchronisation with a serving cell, which was selected during the recovery procedure, such as (e.g., immediately) after a HARQ reset.

In certain representative embodiments, a WTRU 102 may perform COUNT value re-synchronization upon a HARQ reset (e.g., due to handover).

COUNT values for MAC CE and/or MAC UP security enforcements are maintained in the MAC layer and the COUNT values may need to be synchronised between the WTRU 102 and a network node (e.g., 6G BS equivalent to a NR gNB). If a HARQ reset takes place due to a mobility procedure at the WTRU 102, the COUNT values in the MAC entity may need to be initialized to zero at least for the case that the WTRU 102 newly derives MAC security keys during the mobility procedure. For example, HARQ reset takes place when the WTRU 102 performs a mobility procedure (e.g., handover) to change the serving cell to another cell. When the COUNT values are initialised, the MAC keys may (e.g., should) need to be newly derived so as not to have a key replay problem.

In some representative embodiments, COUNT value de-synchronisation may happen between the transmitter and the receiver if the receiver fails to receive more than half of the sequence number space in consecutive data units (e.g., if the SN number field has a 6-bit width, then 2\hat{ }6/2=32 and so if the receiver fails to receive more than 32 data units consecutively, then the receiver can no longer identify the correct COUNT value for the received data unit). Then the following alternatives can be considered.

In certain representative embodiments, there may be transmission prevention prior to a COUNT value de-sync with HARQ involvement. For example, a transmitter (e.g., WTRU 102) may refrain from transmitting any security protected data units (e.g., MAC CE for the case of MAC CE security and/or MAC SDUs, MAC PDUs for the case of MAC UP security) when the WTRU 102's HARQ entity indicates a transmission failure (e.g., has occurred) N times, where N is a threshold to suspend the transmission. For example, a value of N may be either hard coded in a specification (e.g., a hard coded value or the value is calculated based on the configured sequence number space) or may be configured by the network.

In certain representative embodiments, a COUNT value may be reset with HARQ involvement. For example, a transmitter (e.g., WTRU 102) may initialize a corresponding COUNT value(s) when the WTRU 102's HARQ entity indicates the transmission failure (e. g,. has occurred) N times, where N is a threshold to declare the COUNT desynchronisation event. For example, a value of N may be either hard coded in a specification (e.g., a hard coded value or the value is calculated based on configuration, such as the MAC sequence number space) or may be configured by the network. When the WTRU 102 performs the COUNT value initialisation (e.g., as the transmitter) due to the consecutive HARQ transmission failures, the WTRU 102 may transmit a “special” MAC CE (e.g., a COUNT reset MAC CE). This MAC CE may indicate to the network that the WTRU 102 has already reset the COUNT value(s) and expects the network to do the same. For example, the network may send back a confirmation message, which tells the WTRU 102 that the network successfully received this (e.g., COUNT reset) MAC CE and the COUNT initialisation took place at the network accordingly. The WTRU 102 may perform key derivation(s) (e.g., either horizontal key derivation(s) or vertical key derivation(s)) for the MAC security keys (e.g., MAC CE keys and/or MAC UP keys) during the COUNT reset MAC CE exchange procedure so that the WTRU 102 and the network can apply the newly derived keys with the initialized (e.g., zeroed) COUNT value(s) for security protected data exchange.

### COUNT Value Determination for MAC Data Units

As described in this section, the following definitions are used:
HFN: the HFN part (i.e. the number of most significant bits equal to HFN length) of a State Variable;
SN: the SN part (i.e. the number of least significant bits equal to MAC SN length) of a State Variable;
RCVD_SN: the MAC SN of the received MAC data unit, included in the MAC (sub-)header;
RCVD_HFN: the HFN of the received MAC data unit, calculated by the receiving MAC entity;
RCVD_COUNT: the COUNT of the received MAC data unit=[RCVD_HFN, RCVD_SN].
Window_Size: This constant indicates the size of the reordering window for COUNT value calculation. The value equals to 2^{[size of MAC SN]-1};
MAC data unit: This is either MAC CE, MAC SDU or MAC PDU depending on the embodiment described in the earlier subclauses; and
MAC SN. This is either MAC CE SN or MAC UP SN depending on the embodiment described in the earlier subclauses.

In certain representative embodiments, at reception of a MAC data unit from a lower layer (e.g., PHY), the receiving MAC entity may determine the COUNT value for the received MAC data unit as “RCVD_COUNT”. For example, the RCVD_COUNT may be determined as follows:
if RCVD_SN<SN of the received MAC data unit−Window_Size:
RCVD_HFN=HFN of the received MAC data unit +1.
else if RCVD_SN>=SN of the received MAC data unit+Window_Size:
RCVD_HFN=HFN of the received MAC data unit−1.
else:
RCVD_HFN=HFN of the received MAC data unit;

### RCVD_COUNT=[RCVD_HFN, RCVD_SN].

After the COUNT value determination described above, a WTRU 102 may proceed to perform the corresponding security enforcement(s) (e.g., ciphering and/or integrity check processing).

### Per QoS Flow Security Enforcement

In certain representative embodiments, MAC security may be selectively applied, such as on a per data flow (e.g., QoS flow) basis.

In certain representative embodiments, a WTRU 102 may selectively, or conditionally, apply security at the MAC layer as a function of any (e.g., combination) of the following.

For example, security may be applied based on MAC CE type. A WTRU 102 may be configured and/or predefined with a subset of MAC CE types for which it applies MAC security. For example, C-RNTI, LTM, configuration related control elements, MAC CEs carrying physical layer control information (e.g. UCI), BSR, and/or PHR MAC CEs may be used to distinguish types of MAC CEs.

For example, security may be applied based on MAC header type. A WTRU 102 may be predefined and/or configured with a subset of header types for which it applies MAC security. Such headers may be headers of higher layers above the MAC layer and/or headers of the MAC layer itself. Examples of headers and/or fields for which security at MAC may be applied include: PDCP headers (e.g., PDCP Data PDU Header, ROHC Header, PDCP Control PDU Header, RLC headers (e.g., FI, E, SN, P, SO fields), and MAC headers (e.g., LCID, frame control fields).

For example, security may be applied based on upper layer control PDU type. A WTRU 102 may apply MAC security to upper layer control PDUs (e.g., RLC status PDU, PDCP status report, ROHC feedback PDU). The type of control PDUs for which security is applied at lower layers may be predefined and/or configured.

For example, security may be applied based on WTRU 102 processing time and/or timeline. A WTRU 102 may be configured with a minimum processing time for security processing, such as per number of SDUs and/or per number of bits. The WTRU 102 may (e.g., also) be configured with a security processing window (e.g., which may be defined per time, number of bits, or number of PDUs, such as to concatenate). As an example, the WTRU 102 may process security at the MAC layer selectively if the processing time until a grant transmission time starts is larger than the minimum processing time. As an example, the WTRU 102 may process security at the MAC layer selectively if processing for the number of SDUs on which collective integrity protection is applied is smaller than the number of SDUs configured for the processing window. As an example, the WTRU 102 may process security at the MAC layer selectively if processing for the number of bits on which collective integrity protection is applied is smaller than the number of SDUs configured for the processing window.

For example, security may be applied based on WTRU 102 concatenation. A WTRU 102 may apply UPIP collectively for a number of SDUs that are concatenated. The WTRU 102 may have a given processing and/or memory capacity to process a number of SDU (e.g., jointly) prior to the reception of a grant or upon reception of a grant, which may be applied at the MAC or the PDCP layer. For example, a single key can be expanded and used for all concatenated SDUs. As an example, the WTRU 102 may choose to concatenate a number of available SDUs for transmission if the processing time until the grant transmission is less than a threshold and/or if the grant allows the transmission of such concatenated SDUs and/or if segmentation can be avoided for the combined PDU.

For example, security may be applied based on RRC message types and/or RRC states. A WTRU 102 may be configured and/or predefined to apply security on RRC messages in non-connected RRC states (e.g. to CCCH messages and/or I-RNTI messages), such as where a key may be derived from a token derived from broadcast channels (e.g. PBCH, SI) and/or from a broadcast synchronization signal (e.g., the sequence used for PSS and/or SSS), and/or the PCI. The WTRU 102 may determine a key by scrambling the token by a user specific identity or message.

For example, security may be applied based on data type. A WTRU 102 may be configured and/or predefined with a subset of data types for which it applies security and/or integrity protection (or does not). As an example, a data type may be any of control plane data, user plane data, data plane data, machine learning data, sensing data, operational data, model transfer data, etc.

For example, security may be applied based on control data type. A WTRU 102 may be configured and/or predefined with a subset of control information types for which it applies security and/or integrity protection (or does not). As examples, a control information type may be a UCI type (e.g., delivered by a MAC CE, including PMI, CSI, ACK/NACK, SR etc.), an SRB data type, a type of an RRC message, control signalling for third party machine learning server, control signalling for inference and model training, etc.

In some representative embodiments, selective security enforcement may be applicable when upper layer security is configured and/or applied (e.g., in PDCP) and/or when UPIP is configured for the data flow.

In certain representative embodiments, a WTRU 102 may perform partial security, such as for an SDU. In certain representative embodiments, a WTRU 102 may perform partial security, which may include ciphering and/or UPIP for an SDU. As an example, the WTRU 102 may perform ciphering and/or UPIP for a part of an SDU. For example, the WTRU 102 may perform UPIP for a maximum configured number of bits for an SDU. If the size of the SDU is greater than the configured number of bits, the WTRU 102 may perform UPIP for the whole SDU. Otherwise, if the size of the SDU is greater than the configured threshold, the WTRU 102 may only perform UPIP for the configured number of bits for the SDU. This approach may be motivated for the WTRU 102 to guarantee the maximum WTRU 102 processing for UPIP per SDU.

In certain representative embodiments, a WTRU 102 may determine whether or not to perform security for an SDU. In certain representative embodiments, a WTRU 102 may, for each SDU, which may arrive at a layer for security protection (e.g., MAC, PDCP, SDAP, or a new layer such as Data Plane Adaptation Protocol (DPAP)), determine any (e.g., combination) of the following. A WTRU 102 may determine whether to perform security which may include ciphering and/or UPIP for a SDU. A WTRU 102 may determine whether to perform partial or full security for the SDU.

Decisions as to whether to perform security for a SDU and/or whether to perform partial or full security for the SDU may be based on any (e.g., combination) of the following: QoS flow, data flow, QoS treatment profile, one or more QoS parameters, one or more properties of the SDU, a number of SDUs requiring security protection, and/or the processing time for security protection.

In some embodiments, a security processing decision may be based on a QoS flow and/or data flow associated with an SDU. For example, the WTRU 102 may be configured as to whether UPIP is enabled/disabled for each QoS/data flow. The WTRU 102 may perform UPIP for the SDU if it is associated with UPIP enabled QoS/data flow. Otherwise, if UPIP is disabled for the QoS/data flow, the WTRU 102 may not perform UPIP for the SDU. For example, the WTRU 102 may be configured with partial UPIP for the SDUs in a QoS/data flow, in which the WTRU 102 may be configured to perform UPIP up to X bits. The WTRU 102 may then perform UPIP for X bits of an SDU if the size of the SDU is greater than X bits. Otherwise, if the size of an SDU is smaller than X bits, the WTRU 102 may perform UPIP for the whole SDU.

In some embodiments, a security processing decision may be based on the QoS treatment profile (e.g., RB/LCH) associated with the SDU. For example, the WTRU 102 may be configured whether security is enabled/disabled for each QoS treatment profile (e.g., RB/LCH). The WTRU 102 may perform security for the SDU if it is associated with a security protection enabled QoS treatment profile (e.g., RB/LCH). Otherwise, if security protection is disabled for the QoS treatment profile (e.g., RB/LCH), the WTRU 102 may not perform security protection for the SDU.

In some embodiments, a security processing decision may be based on the QoS parameters, such as the (e.g., remaining) delay budget, the priority or importance, associated with the SDU. For example, the WTRU 102 may determine whether to perform UPIP for an SDU based on the (e.g., remaining) delay budget associated with the SDU. As an example, if the (e.g., remaining) delay budget associated with the SDU is smaller than a configured threshold, the WTRU 102 may skip UPIP for the SDU. Otherwise, if the (e.g., remaining) delay budget associated with the SDU is larger than the configured threshold, the WTRU 102 may perform UPIP for the SDU.

In some embodiments, a security processing decision may be based on a property (e.g., the size, the type of the SDU such as data SDU, control SDU, AIML data, AIML training data, AIML inference data, AIML collection data, sensing data, and/or sensing data) associated with the SDU. For example, the WTRU 102 may perform UPIP for the SDU if the size of the SDU is smaller, or larger, than a configured threshold. Otherwise, if the size of the SDU is larger, or smaller, than the configured threshold, the WTRU 102 may not perform UPIP for the SDU. For example, the WTRU 102 may perform UPIP for a control SDU (e.g., PDCP SDU) in the PDCP layer. Otherwise, if the SDU is a data one, the WTRU 102 may not perform UPIP for the SDU.

In some embodiments, a security processing decision may be based on the minimum and/or maximum ratio of SDUs requiring security protection. For example, the WTRU 102 may be configured to perform UPIP for a minimum ratio of SDUs. The WTRU 102 may then perform UPIP for at least the minimum configured ratio. The WTRU 102 may (e.g., then) not perform UPIP for any remaining SDUs. For example, the WTRU 102 may be configured to perform UPIP for at least one SDU out of a set (e.g., 10) SDUs. The WTRU 102 may (e.g., then) perform UPIP for one SDU for every set of SDUs. The WTRU 102 may not perform UPIP for the remaining SDUs of the set.

In some embodiments, a security processing decision may be based on the minimum and/or maximum number of SDUs requiring security protection within a window. The minimum and/or maximum number of SDUs requiring security protection may be configured for each data and/or QoS flow, each QoS treatment profile (e.g., RB/LCH), and/or for the WTRU 102 itself. For example, the WTRU 102 may be configured to perform UPIP for a minimum number of SDUs within a window. For each window, the WTRU 102 may then perform UPIP for at least a minimum number of SDUs. The WTRU 102 may then not perform UPIP for the remaining SDUs in the window. For example, the WTRU 102 may be configured to perform UPIP for at least 10 SDUs for one RB within a time window (e.g., 10 ms). The WTRU 102 may then perform UPIP for at least 10 SDUs per window (e.g., of 10 ms). The WTRU 102 may then not perform UPIP for any remaining SDUs within the window.

In some embodiments, a security processing decision may be based on the minimum and/or maximum WTRU 102 processing associated with security protection within a configured duration. For example, the WTRU 102 may be configured with a maximum WTRU 102 processing for UPIP within a window. The WTRU 102 may then perform UPIP until the maximum WTRU 102 processing is reached. The WTRU 102 may then (e.g., be allowed) to skip any remaining SDUs within the window.

In certain representative embodiments, a WTRU 102 may determine whether to perform UPIP for an SDU based on the QoS treatment profile (e.g., RB) and the importance associated with the SDU. As an example, for a QoS treatment profile (e.g., RB) with UPIP enabled, the WTRU 102 may be configured to perform UPIP for high importance SDUs (e.g., an SDU having an importance being greater than a configured threshold). Otherwise, if SDU is not important (e.g., the importance of the SDU is smaller than a configured threshold), the WTRU 102 may not perform UPIP for the SDU.

In certain representative embodiments, a WTRU 102 may be configured to perform UPIP for a maximum, or minimum, number of SDUs within window. The WTRU 102 may then perform UPIP for the SDUs until the maximum, or minimum, number of SDUs is reached. The WTRU 102 may skip any remaining SDUs in the window.

In certain representative embodiments, a WTRU 102 may prioritize which SDU(s) to perform security protection for.

In certain representative embodiments, a WTRU 102 may have multiple SDUs on which to perform security protection (e.g., multiple SDUs with security protection enabled). The WTRU 102 may not be able to perform security protection for all SDUs. The WTRU 102 may then determine which of the SDUs to prioritize for security protection. Such decisions may be determined based on any (e.g., combination) of the following: configuration information, network indication, QoS parameters, and/or a property of the SDUs.

In some embodiments, a WTRU 102 may prioritize security processing based on a configuration and/or indication from the network. For example, the WTRU 102 may be configured, such as per QoS and/or data flow and/or QoS treatment profile, with the relative priority associated with the UPIP. The WTRU 102 may then prioritize to perform UPIP associated with high relative priority of UPIP until the configured maximum, or minimum, UPIP operation is reached.

In some embodiments, a WTRU 102 may prioritize security processing based on QoS parameters (e.g., the (remaining) delay budget, the priority or importance) associated with the SDU. For example, the WTRU 102 may prioritize to perform UPIP for high priority and/or importance SDUs.

In some embodiments, a WTRU 102 may prioritize security processing based on a property (e.g., the size, the type of the SDU such as data SDU, control SDU, AIML data, AIML training data, AIML inference data, AIML collection data, sensing data, and/or sensing data) associated with the SDU. For example, the WTRU 102 may first prioritize to perform UPIP for control SDUs. For example, the WTRU 102 may (e.g., then) prioritize to perform UPIP for the SDUs with larger size(s).

In certain representative embodiments, a WTRU 102 may indicate as to whether security is enforced, or not, for each SDU.

In certain representative embodiments, a WTRU 102 may be configured to perform selective security (e.g., ciphering and/or UPIP). The WTRU 102 may then indicate in the SDU header whether security protection is enabled, or disabled, for the SDU. Such an indication may enable the network to determine whether to apply a security algorithm to decode the SDU. For a received SDU, the WTRU 102 may be also indicated (e.g., in the header of the SDU) whether security enforcement is enabled, or disabled. If security enforcement is enabled, the SDU may perform the security algorithm (e.g., deciphering, UPIP decoding) to decode the SDU. Otherwise, if the WTRU 102 receives indication of security enforcement disabled (e.g., UPIP disabled), the WTRU 102 may skip the decoding of the SDU and forward it to another reception function (e.g., layer) for processing of the SDU.

### Example Solutions

In certain representative embodiments, a WTRU 102 may generate (e.g., derive) MAC security keys, such as a first MAC security key for confidentiality (e.g., a MAC confidentiality key) and a second MAC security key for integrity protection (e.g., a MAC integrity protection key). The WTRU 102 may store (e.g., maintain) the MAC security keys and a corresponding COUNT value (e.g., for replay protection).

In certain representative embodiments, a WTRU 102 may detect a security activation trigger and generate (e.g., derive) a (e.g., set of) 6G Base Station (BS) key(s). For example, a security activation trigger may include, among other triggers, any of a change in/of a serving 6G Upper Layer Unit (ULU), and/or reception of a security mode command message.

In certain representative embodiments, the WTRU 102 may generate (e.g., derive), based on the set of 6G BS keys, a set of integrity protection and confidentiality keys. For example, the set of integrity protection and confidentiality keys may include a RRC integrity protection key, an RRC confidentiality key, a UP-integrity protection key, a UP-confidentiality key, and a MAC intermediate key. For example, the set of integrity protection and confidentiality keys may be derived by (e.g., additionally) using a network node identifier. For example, a network node identifier may be any of a physical cell identity, a 6G Lower Layer Unit (LLU) identifier, and/or a 6G ULU identifier.

In certain representative embodiments, the WTRU 102 may determine (e.g., detect) a MAC security key update trigger and generate (e.g., derive) a MAC intermediate key. For example, the MAC security key update trigger may include, among other triggers, a change in/of a serving 6G LLU, and/or a change in/of a serving cell (e.g., via a mobility procedure, such as a handover).

In certain representative embodiments, the WTRU 102 may generate (e.g., derive) a MAC CE integrity protection key and a MAC CE confidentiality key. For example, the MAC CE integrity protection key and the MAC CE confidentiality key may be collectively referred to as MAC CE keys. For example, the MAC CE integrity protection key and the MAC CE confidentiality key may be derived based on the MAC intermediate key (e.g., when the MAC intermediate key is newly derived).

In certain representative embodiments, the WTRU 102 may initialize a COUNT value associated with MAC CE signaling to zero (e.g., when the MAC CE keys are derived).

In certain representative embodiments, a WTRU 102 may determine security keys (e.g., MAC CE keys as described above).

In certain representative embodiments, the WTRU 102 may perform (e.g., DL) security enforcement using the derived MAC security keys. For example, the WTRU 102 may receive a MAC CE (e.g., from a lower layer).

In certain representative embodiments, the WTRU 102 may (e.g., for decryption of a received MAC CE) use the MAC confidentiality key and a COUNT value associated with DL MAC control signaling as the KEY and COUNT input parameters for a confidentiality algorithm (e.g., configured by the network).

In certain representative embodiments, the WTRU 102 may (e.g., for an integrity check of a received MAC CE) use the MAC integrity protection key and a COUNT value associated with DL MAC control signaling as the KEY and COUNT input parameters for an integrity protection algorithm (e.g., configured by the network).

In certain representative embodiments, the WTRU 102 may perform SN-based management of the COUNT value. For example, a security protected MAC CE may be associated with a SN (e.g., defined per direction). The SN may be the least significant N-bits (e.g., LSBs) of the COUNT value, where N is an integer value. The SN may be initialized upon COUNT value initialization. The remaining MSBs of the COUNT value may be incremented by 1 when the SN is wrapped around. The SN may be included in a MAC CE, such as in a SN field which is added in a MAC CE which requires security protection.

In certain representative embodiments, for the DL direction, the WTRU 102 may update the COUNT value associated with DL MAC control signalling with the SN given by successfully received security protected downlink MAC control signalling.

In certain representative embodiments, a WTRU 102 may determine security keys (e.g., MAC CE keys as described above).

In certain representative embodiments, the WTRU 102 may generate a MAC CE (e.g., which requires security protection). For example, the WTRU 102 may determine that security protection should be, or is, provided for the MAC CE. For example, the WTRU 102 may receive a security protection requirement (e.g., signalled by the network), such as for mobility related signalling including a LTM cell switch command.

In certain representative embodiments, the WTRU 102 may perform (e.g., UL) security enforcement using the derived MAC security keys. For example, the WTRU 102 may generate a MAC CE (e.g., for UL transmission by a lower layer). The WTRU 102 may determine the COUNT value associated with MAC CE control signaling (e.g., for the UL direction) and determine a SN associated with the MAC CE based on the determined COUNT value. For example, the WTRU 102 may append the SN, or a subset of the SN bits (e.g., include a predefined number of bits from the lowest significant bits of the COUNT value), to the generated MAC CE. For example, the SN may be the (e.g., N) least significant bits of the COUNT value. For example, the remaining most significant bits of the COUNT value may be maintained as a Hyper Frame Number (HFN).

In certain representative embodiments, the WTRU 102 may apply ciphering (e.g., encryption) to the MAC CE using the MAC confidentiality key and the determined COUNT value.

In certain representative embodiments, the WTRU 102 may apply integrity protection to the MAC CE using the MAC integrity protection key and the determined COUNT value.

In certain representative embodiments, the WTRU 102 may transmit the security protected MAC CE. For example, the WTRU 102 may increment the COUNT value by 1 when the MAC CE is delivered to a lower layer (e.g. PHY) for transmission.

In certain representative embodiments, a WTRU 102 may derive a 6G BS key (e.g., equivalent to K_{gNB}) upon security activation (e.g., receiving a security mode command) and/or upon a change of the WTRU's serving 6G ULU after the security activation.

In certain representative embodiments, the WTRU 102 may derive an RRC integrity protection key, an RRC confidentiality key, a UP-integrity protection key, a UP-confidentiality key, and a MAC intermediate key using (e.g., from) the 6G BS key, such as when the 6G BS key is newly derived.

In certain representative embodiments, the WTRU 102 may (e.g., newly) derive a MAC intermediate key upon a change of the serving 6G LLU. The MAC intermediate key may be derived based on a cell identity and/or an identity of the 6G LLU. For example, a MAC CE integrity protection key and a MAC CE confidentiality key (e.g., MAC CE keys) for MAC CE protection may be derived from the MAC intermediate key when the MAC intermediate key is (e.g., newly) derived. For example, the MAC intermediate kay may be derived upon security activation (e.g. via a security mode command). For example, the MAC intermediate key may be derived upon a serving 6G LLU change. For example, the MAC CE keys may be derived when the service cell of the WTRU 102 changes (e.g., handover). For example, the MAC CE keys may be derived based on a (e.g., serving) cell identity and/or an identity of the (e.g., serving) 6G LLU.

In certain representative embodiments, the WTRU 102 may initialize the COUNT value associated with the MAC CE signaling to zero when the MAC integrity-protection key and MAC confidentiality key are (e.g., newly) derived.

In certain representative embodiments, a WTRU 102 may maintain security (e.g., MAC CE) keys as described herein.

In certain representative embodiments, the WTRU 102 may generate a MAC CE, which requires security protection. For example, a security protection requirement may be signaled by the network (e.g., security protection is required, such as for mobility related signaling including a LTM cell switch command).

In certain representative embodiments, the WTRU 102 may, for encryption (e.g., as part of UL security enforcement), use the MAC confidentiality key and a COUNT value for UL MAC CEs as the KEY and COUNT input parameters for a confidentiality algorithm (e.g., configured by the network).

In certain representative embodiments, the WTRU 102 may, for integrity protection (e.g., as part of UL security enforcement), use the MAC integrity protection key and a COUNT value for UL MAC CEs as the KEY and COUNT input parameters for an integrity protection algorithm (e.g., configured by the network). For example, the WTRU 102 may generate a MAC-I via processing the integrity protection algorithm for the MAC CE. For example, the WTRU 102 may place the MAC-I for the MAC-CE in a MAC PDU including the MAC CE.

In certain representative embodiments, a WTRU 102 may maintain security (e.g., MAC CE) keys as described herein.

In certain representative embodiments, the WTRU 102 may generate a MAC CE, which requires security protection. For example, a security protection requirement may be signaled by the network (e.g., security protection is required, such as for mobility related signalling including a LTM cell switch command).

In certain representative embodiments, the WTRU 102 may, for decryption (e.g., as part of DL security enforcement), use the MAC confidentiality key and a COUNT value for DL MAC control signaling as the KEY and COUNT input parameters for a confidentiality algorithm (e.g., configured by the network).

In certain representative embodiments, the WTRU 102 may, for integrity checking (e.g., as part of DL security enforcement), use the MAC integrity protection key and a COUNT value for DL MAC control signaling as the KEY and COUNT input parameters for an integrity protection algorithm (e.g., configured by the network).

In certain representative embodiments, a security protected MAC CE may be associated with a SN (e.g., defined per communication direction). The SN may be N-bits (e.g., N LSBs) of the COUNT value (e.g., the SN is initialized upon the COUNT value initialization). The remaining MSBs of the COUNT value may be incremented by one when the SN is wrapped around. The SN may be included in the MAC CE (e.g., a SN field is added in the MAC CE which requires security protection).

In certain representative embodiments, for the UL direction, a WTRU 102 may increment the SN by one when the WTRU 102 delivers security protected uplink MAC control signaling to a lower layer (e.g., PHY).

In certain representative embodiments, for the DL direction, a WTRU 102 may update the COUNT value for downlink MAC control signaling with a SN given by successfully received security protected downlink MAC control signaling.

In certain representative embodiments, for the UL direction, when the WTRU 102 (e.g., MAC entity) delivers a security protected MAC CE to the lower layer (e.g., PHY), the WTRU 102 (e.g., MAC entity) may increment the COUNT value for UL MAC CEs by one. For the DL direction, when the WTRU 102 (e.g., MAC entity) receives a DL MAC CE, then the WTRU 102 (e.g., MAC entity) may increment the COUNT value for downlink MAC control signaling by one.

In certain representative embodiments, for the UL direction, when a WTRU 102 (e.g., MAC entity) generates a MAC CE, which requires security protection, the WTRU 102 (e.g., MAC entity) uses a SN, which is present in the user data, which is concatenated in the same MAC PDU as the MAC CE to set the UL COUNT value (e.g., the LSBs of the COUNT are set to the SN borrowed from a user data MAC SDU) and the uplink MAC CE indicates a logical channel ID (e.g., where the SN is borrowed). For the DL direction, when a WTRU 102 (e.g., MAC entity) receives a security protected MAC CE, the WTRU 102 (e.g., MAC entity) may pick up a sequence number in the MAC SDU associated with a data flow indicated by the received MAC CE and may set the DL COUNT value based on this SN (e.g., the LSBs of the downlink COUNT value are set to the SN). For example, the user data may have SN which is determined at any of the PDCP layer, RLC layer, or QoS flow level.

In certain representative embodiments, a transmitting MAC entity may use a single set of COUNT and MAC CE keys per MAC PDU to secure one or more MAC CEs in the same MAC PDU (e.g., the same COUNT value is applied for all the MAC CEs within the same MAC PDU and a single SN is present in the MAC PDU header for security enforcement purposes).

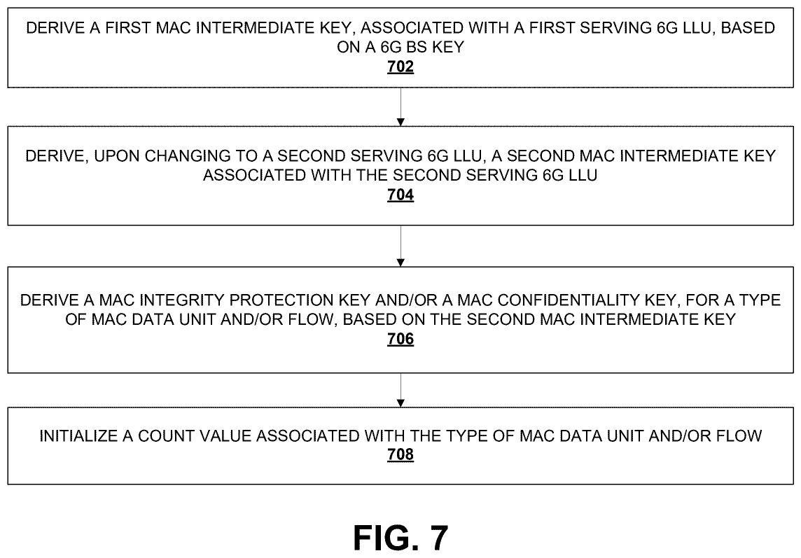

FIG. 7 is a procedural diagram illustrating an example key derivation procedure, according to one or more embodiments of the present disclosure.

As shown in FIG. 7, a WTRU 102 (e.g., for transmission or reception purposes) may derive a first MAC intermediate key, associated with a first serving 6G LLU, based on a 6G BS key at 702. At 704, the WTRU 102 may derive, such as upon changing to a second serving 6G LLU, a second MAC intermediate key associated with the second serving 6G LLU. At 708, the WTRU may derive a MAC integrity protection key and/or a MAC confidentiality key, for a type of MAC data unit (e.g., MAC CEs, MAC SDUs, MAC PDUs), based on the second MAC intermediate key. For example, the WTRU 102 may derive MAC CE keys for security protection associated with MAC CEs. For example, the WTRU 102 may derive MAC UP keys for security protection associated with MAC user data. At 710, the WTRU 102 may initialize a COUNT value associated with the type of MAC data unit.

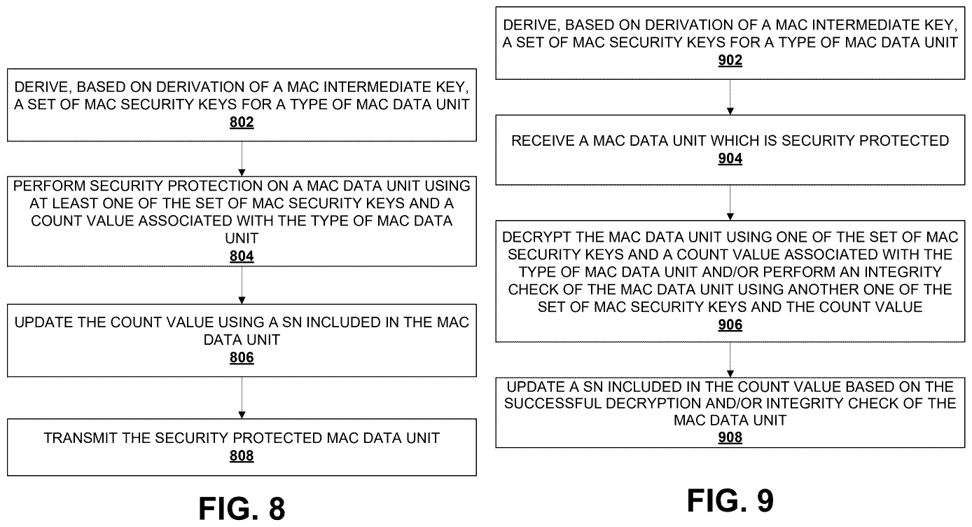

FIG. 8 is a procedural diagram illustrating an example transmission procedure for security protection, according to one or more embodiments of the present disclosure. In some embodiments a WTRU 102, as a transmitting entity, may implement the procedure shown in FIG. 8. In other embodiments, a 6G BS may act as the transmitting entity.

As shown in FIG. 8, a WTRU 102 may derive, based on derivation of a MAC intermediate key, a set of MAC security keys for a type of MAC data unit at 802. At 804, the WTRU 102 may perform security protection on a MAC data unit using at least one of the set of MAC security keys and a COUNT value associated with the type of MAC data unit. At 806, the WTRU 102 may update the COUNT value using a SN included in the MAC data unit. At 808, the WTRU 102 may transmit the security protected MAC data unit. For example, the security protected MAC data unit may be submitted for lower layer processing and transmission.

FIG. 9 is a procedural diagram illustrating an example reception procedure for security protection, according to one or more embodiments of the present disclosure. In some embodiments a WTRU 102, as a receiving entity, may implement the procedure shown in FIG. 8. In other embodiments, a 6G BS may act as the receiving entity.

As shown in FIG. 9, a WTRU 102 may derive, based on derivation of a MAC intermediate key, a set of MAC security keys for a type of MAC data unit at 902. At 904, the WTRU 102 may receive a MAC data unit which is security protected. For example, the security protected MAC data unit may be received after lower layer processing. At 906, the WTRU 102 may decrypt the MAC data unit using one (e.g., a MAC confidentiality key) of the set of MAC security keys and a COUNT value associated with the type of MAC data unit and/or perform an integrity check of the MAC data unit using another one (e.g., a MAC integrity key) of the set of MAC security keys and the COUNT value. At 908, the WTRU 102 may update a SN included in the COUNT value based on the successful decryption and/or integrity check of the MAC data unit.

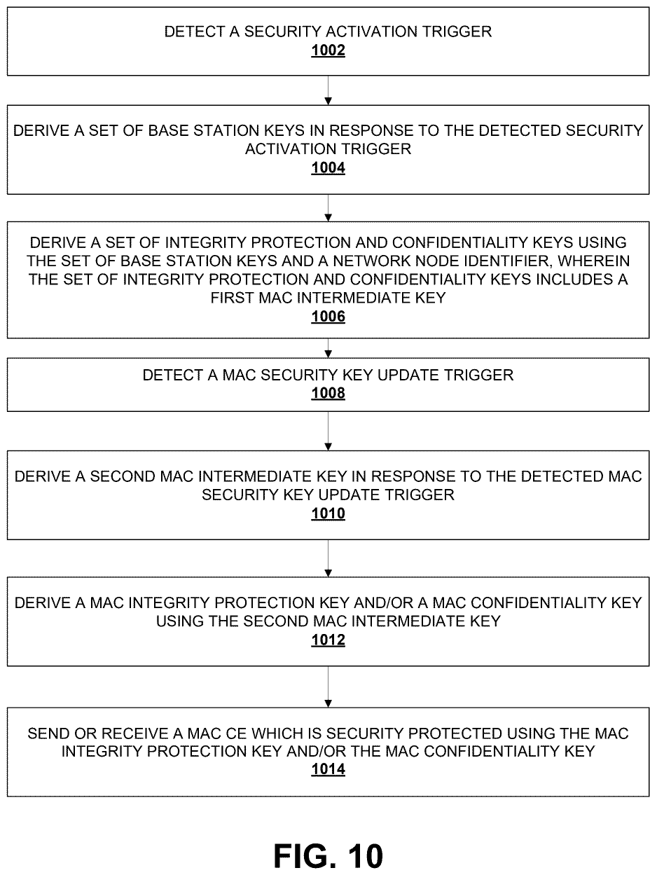

FIG. 10 is a procedural diagram illustrating an example key derivation and communication procedure for security protection, according to one or more embodiments of the present disclosure.

As shown in FIG. 10, a WTRU 10 may detect a security activation (or update) trigger at 1002. At 1004, the WTRU 102 may derive (e.g., determine) a set of base station keys in response to the detected security activation trigger. At 1006, the WTRU 102 may derive (e.g., determine) a set of integrity protection and confidentiality keys using (e.g., based on) the set of base station keys and a network node identifier. For example, the set of integrity protection and confidentiality keys includes a first MAC intermediate key. At 1008, the WTRU 102 may detect a MAC security key update trigger. At 1010, the WTRU 102 may derive (e.g., determine) a second MAC intermediate key in response to the detected MAC security key update trigger. For example, the second MAC intermediate key may be derived using (e.g., based on) the set of base station keys and a (e.g., new or current) network node identifier. At 1012, the WTRU 102 may determine a MAC integrity protection key and/or a MAC confidentiality key using (e.g., based on) the second MAC intermediate key. For example, the MAC integrity protection key and/or the MAC confidentiality may be derived using (e.g., based on) the (e.g., new or current) network node identifier. At 1014, the WTRU 102 may send or receive a MAC CE which is security protected using the MAC integrity protection key and/or the MAC confidentiality key. For example, the MAC CE may be security protected using a COUNT value and the MAC integrity protection key and/or the MAC confidentiality key (e.g., as input parameters to the corresponding integrity protection and/or confidentiality algorithms).

In some embodiments, the WTRU 102 may detect the security activation trigger in response to a change of a serving 6G ULU.

In some embodiments, the WTRU 102 may detect the security activation trigger in response to reception of a security mode command message.

In some embodiments, the set of integrity protection and confidentiality keys includes any of a RRC integrity protection key, a RRC confidentiality key, a UP integrity protection key, and/or a UP confidentiality key.

In some embodiments, the network node identifier may include any of a physical cell identity, a LLU identifier, and/or a ULU identifier.

In some embodiments, the WTRU 102 may detect the MAC security key update trigger in response to a change of a serving (e.g., 6G) LLU.

In some embodiments, the WTRU 102 may detect the MAC security key update trigger in response to a change of a serving cell (e.g., from a current serving cell to a target cell).

In some embodiments, the WTRU 102 may determine the MAC integrity protection key and the MAC confidentiality key in response to (e.g., upon) the derivation of the second MAC intermediate key.

In some embodiments, the WTRU 102 may initialize a COUNT value associated with MAC CE signaling to zero upon derivation of the MAC integrity protection key and the MAC confidentiality key.

In some embodiments, the WTRU 102 may derive another MAC integrity protection key and/or another MAC confidentiality key using the first MAC intermediate key prior to detection of the MAC security key update trigger. For example, these MAC keys may be used for security protection of MAC CEs prior to detection of the MAC security key update trigger.

In some embodiments, the MAC integrity protection key may be a MAC CE integrity protection key. In some embodiments, the MAC confidentiality key may be a MAC CE confidentiality key. For example, security protection of a MAC CE may be performed as described herein using these MAC CE keys.

In some embodiments, the MAC integrity protection key may be a MAC UP integrity protection key. In some embodiments, the MAC confidentiality key may be a MAC UP confidentiality key. For example, security protection of a MAC CE may be performed as described herein using these MAC UP keys.

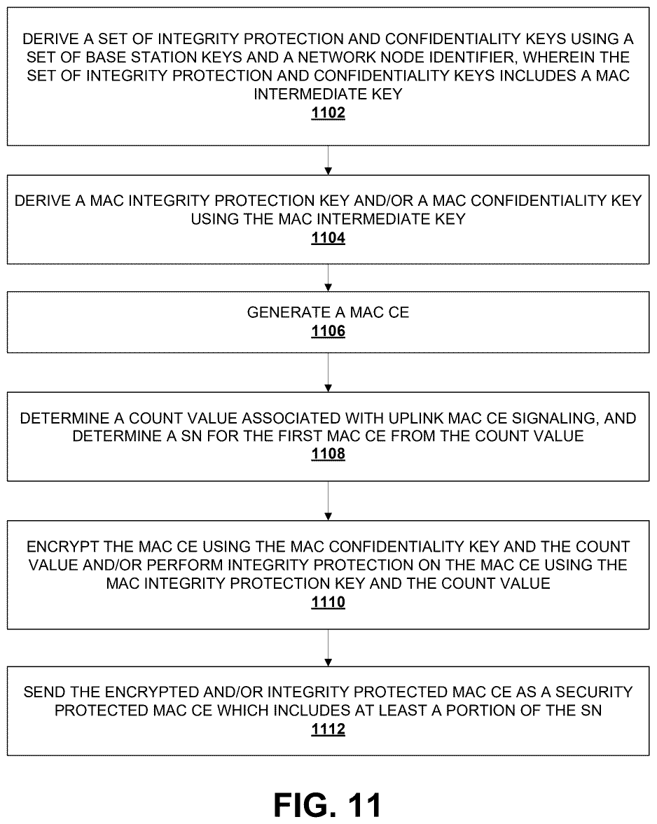

FIG. 11 is a procedural diagram illustrating another example transmission procedure for security protection, according to one or more embodiments of the present disclosure. As shown in FIG. 11, a WTRU 102 (e.g., as a transmitting entity) may derive a set of integrity protection and confidentiality keys using a set of base station keys and a network node identifier at 1102. For example, the set of integrity protection and confidentiality keys includes a MAC intermediate key. At 1104, the WTRU 102 may derive a MAC integrity protection key and/or a MAC confidentiality key using (e.g., based on) the MAC intermediate key. At 1106, the WTRU 102 may generate a MAC CE. At 1108, the WTRU 102 may determine a COUNT value associated with uplink MAC CE signaling, and determine a SN for the MAC CE from the COUNT value. At 1110, the WTRU 102 may encrypt the MAC CE using the MAC confidentiality key and the COUNT value and/or perform integrity protection on the MAC CE using the MAC integrity protection key and the COUNT value. At 1112, the WTRU 102 may send the encrypted and/or integrity protected MAC CE as a security protected MAC CE which includes at least a portion of the SN.

In some embodiments, the WTRU 102 may detect a security activation trigger. For example, the WTRU 102 may derive the set of base station keys in response to the detected security activation trigger.

In some embodiments, the WTRU 102 may determine the SN from a set of N least significant bits (LSBs) of the COUNT value.

In some embodiments, a remainder of most significant bits (MSBs) of the COUNT value may correspond to a HFN. For example, the WTRU 102 may determine the HFN from the remaining MSBs of the COUNT value.

In some embodiments, the WTRU 102 may encrypt the MAC CE using the MAC confidentiality key and the COUNT value as inputs to a network-configured confidentiality algorithm.

In some embodiments, the WTRU 102 may perform the integrity protection on the MAC CE using the MAC integrity protection key and the COUNT value as inputs to a network-configured integrity protection algorithm.

In some embodiments, the WTRU 102 may initialize the COUNT value to zero upon derivation of the MAC integrity protection key and the MAC confidentiality key.

In some embodiments, the security protected MAC CE includes a field including information indicating the at least the portion of the SN.

In some embodiments, the WTRU 102 may update (e.g., increment) the COUNT value by one upon delivery of the security protected MAC CE for physical layer processing.

In some embodiments, the network node identifier may include any of a physical cell identity, a LLU identifier, and/or an ULU identifier.

In some embodiments, the MAC integrity protection key may be a MAC CE integrity protection key. In some embodiments, the MAC confidentiality key may be a MAC CE confidentiality key. For example, security protection of a MAC CE may be performed as described herein using these MAC CE keys.

In some embodiments, the MAC integrity protection key may be a MAC UP integrity protection key. In some embodiments, the MAC confidentiality key may be a MAC UP confidentiality key. For example, security protection of a MAC CE may be performed as described herein using these MAC UP keys.

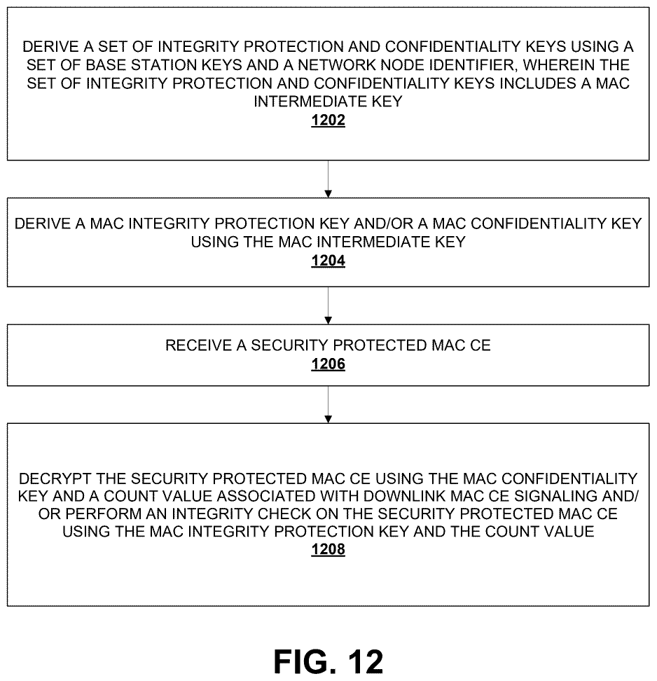

FIG. 12 is a procedural diagram illustrating another example reception procedure for security protection, according to one or more embodiments of the present disclosure.

As shown in FIG. 12, a WTRU 102 (e.g., as a receiving entity) may derive a set of integrity protection and confidentiality keys using (e.g., based on) a set of base station keys and a network node identifier at 1202. For example, the set of integrity protection and confidentiality keys includes a MAC intermediate key. At 1204, the WTRU 102 may derive a MAC integrity protection key and/or a MAC confidentiality key using (e.g., based on) the MAC intermediate key. For example, the derivation at 1204 may use, or otherwise be based on a network node identifier (e.g., current serving cell identity, LLU identifier, ULU identifier). At 1206, the WTRU 102 may receive a security protected MAC CE. At 1208, the WTRU 102 may decrypt the security protected MAC CE using the MAC confidentiality key and a COUNT value associated with downlink MAC CE signaling and/or perform an integrity check on the security protected MAC CE using the MAC integrity protection key and the COUNT value.

In some embodiments, the WTRU 102 may detect a security activation trigger. The WTRU 102 may derive the set of base station keys in response to the detected security activation trigger.

In some embodiments, the WTRU 102 may determine the COUNT value from a SN ssociated with the security protected MAC CE.

In some embodiments, the WTRU 102 may update a set of N LSBs of the COUNT value based on the SN associated with the security protected MAC CE. For example, the SN may be indicated in a SN field of the MAC CE.

In some embodiments, a remainder of MSBs of the COUNT value may correspond to a HFN. For example, the WTRU 102 may maintain the HFN (e.g., based on the LSBs of the COUNT value).

In some embodiments, the WTRU 102 may decrypt the security protected MAC CE using the MAC confidentiality key and the COUNT value as inputs to a network-configured confidentiality algorithm.

In some embodiments, the WTRU 102 may perform the integrity check on the security protected MAC CE using the MAC integrity protection key and the COUNT value as inputs to a network-configured integrity protection algorithm.

In some embodiments, the WTRU 102 may initialize the COUNT value to zero upon derivation of the MAC integrity protection key and the MAC confidentiality key.

In some embodiments, the network node identifier includes any of a physical cell identity, a LLU identifier, and/or an ULU identifier.

In some embodiments, the MAC integrity protection key may be a MAC CE integrity protection key. In some embodiments, the MAC confidentiality key may be a MAC CE confidentiality key. For example, security protection of a MAC CE may be performed as described herein using these MAC CE keys.

In some embodiments, the MAC integrity protection key may be a MAC UP integrity protection key. In some embodiments, the MAC confidentiality key may be a MAC UP confidentiality key. For example, security protection of a MAC CE may be performed as described herein using these MAC UP keys.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, deriving, generating, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

Each of the contents of the following references is incorporated by reference herein:
(1) 3GPP Study Item S3-221118, “New SID on 5G User plane security enhancements”, Samsung;
(2) 3GPP Study Item S3-223568, “New SID on 5G Per-QoS Flow User Plane Security Control”, Intel;
(3) 3GPP TS 33.102, “3G Security; Security Architecture”, v19.0.0(2025003 -25);
(4) 3GPP TS 33.401, “3GPP System Architecture Evolution (SAE); Security architecture”, v18.3.0 (2025 Mar. 25);
(5) 3GPP TS 33.501, “Security architecture and procedures for 5G system”, v19.2.0(2025 Mar. 25);
(6) 3GPP RP-211345, “Revised WID on NR Dynamic spectrum sharing (DSS)”, June 2021;
(7) “5G Networks Dynamic Spectrum Sharing” https://www.5g-networks.net/5g-dynamic-spectrum-sharing-dss/”;
(8) 3GPP TS 38.331, “NR; Radio Resource Control (RRC); Protocol specification”, v18.5.1 (2025 Mar. 21);
(9) 3GPP TS 38.321, “NR; Medium Access Control (MAC) protocol specification”, v18.5.0 (2025 Mar. 21); and
(10) 3GPP TS 38.212, “NR; Multiplexing and channel coding”, v18.6.0(2025 Mar. 24).

What is claimed is:

1. A wireless transmit/receive unit (WTRU) comprising:
a processor, memory, and a transceiver which are configured to:
detect a security activation trigger,
derive a set of base station keys in response to the detected security activation trigger,
derive a set of integrity protection and confidentiality keys using the set of base station keys and a network node identifier, wherein the set of integrity protection and confidentiality keys includes a first medium access control (MAC) intermediate key,
detect a MAC security key update trigger,
derive a second MAC intermediate key using the set of the base station keys in response to the detected MAC security key update trigger,
derive a MAC integrity protection key and/or a MAC confidentiality key using the second MAC intermediate key, and
send or receive a MAC CE which is security protected using the MAC integrity protection key and/or the MAC confidentiality key.

2. The WTRU of claim 1, wherein the processor, memory, and the transceiver are configured to detect the security activation trigger in response to a change of a serving upper layer unit (ULU).

3. The WTRU of claim 1, wherein the processor, memory, and the transceiver are configured to detect the security activation trigger in response to reception of a security mode command message.

4. The WTRU of claim 1, wherein the set of integrity protection and confidentiality keys includes any of a radio resource control (RRC) integrity protection key, a RRC confidentiality key, a user plane (UP) integrity protection key, and/or a UP confidentiality key.

5. The WTRU of claim 1, wherein the network node identifier includes any of a physical cell identity, a lower layer unit (LLU) identifier, and/or a upper layer unit (ULU) identifier.

6. The WTRU of claim 1, wherein the processor, memory, and the transceiver are configured to detect the MAC security key update trigger in response to a change of a serving lower layer unit (LLU) and/or a change of a serving upper layer unit (ULU).

7. The WTRU of claim 1, wherein the processor, memory, and the transceiver are configured to detect the MAC security key update trigger in response to a change of a serving cell.

8. The WTRU of claim 1, wherein the processor, memory, and the transceiver are configured to derive the MAC integrity protection key and the MAC confidentiality key in response to the derivation of the second MAC intermediate key.

9. The WTRU of claim 1, wherein the processor, memory, and the transceiver are configured to initialize a count value associated with MAC CE signaling to zero upon derivation of the MAC integrity protection key and the MAC confidentiality key.

10. The WTRU of claim 1, wherein the processor, memory, and the transceiver are configured to derive another MAC integrity protection key and/or another MAC confidentiality key using the first MAC intermediate key in response to detection of the MAC security key update trigger.

11. A method implemented by a wireless transmit/receive unit (WTRU), the method comprising:
detecting a security activation trigger;
deriving a set of base station keys in response to the detected security activation trigger;
deriving a set of integrity protection and confidentiality keys using the set of base station keys and a network node identifier, wherein the set of integrity protection and confidentiality keys includes a first medium access control (MAC) intermediate key;
detecting a MAC security key update trigger;
deriving a second MAC intermediate key in response to the detected MAC security key update trigger;
deriving a MAC integrity protection key and/or a MAC confidentiality key using the second MAC intermediate key; and
sending or receiving a MAC control element (CE) which is security protected using the MAC integrity protection key and/or the MAC confidentiality key.

12. The method of claim 11, wherein the security activation trigger is detected in response to a change of a serving upper layer unit (ULU).

13. The method of claim 11, wherein the security activation trigger is detected in response to reception of a security mode command message.

14. The method of claim 11, wherein the set of integrity protection and confidentiality keys includes any of a radio resource control (RRC) integrity protection key, a RRC confidentiality key, a user plane (UP) integrity protection key, and/or a UP confidentiality key.

15. The method of claim 1, wherein the network node identifier includes any of a physical cell identity, a lower layer unit (LLU) identifier, and/or a upper layer unit (ULU) identifier.

16. The method of claim 11, wherein the MAC security key update trigger is detected in response to a change of a serving lower layer unit (LLU) and/or a change of a serving upper layer unit (ULU).

17. The method of claim 11, wherein the MAC security key update trigger is detected in response to a change of a serving cell.

18. The method of claim 11, wherein the MAC integrity protection key and the MAC confidentiality key are derived in response to the derivation of the second MAC intermediate key.

19. The method of claim 11, further comprising:
initializing a count value associated with MAC CE signaling to zero upon derivation of the MAC integrity protection key and the MAC confidentiality key.

20. The method of claim 11, further comprising:
deriving another MAC integrity protection key and/or another MAC confidentiality key using the first MAC intermediate key in response to detection of the MAC security key update trigger.

21.-60. (canceled)
